(19) United States
(12) Patent Application Publication
(10) Pub. No.: US 2025/0303563 A1
(43) Pub. Date: Oct. 2, 2025

(54) SYSTEMS AND METHODS FOR SAFE EXPLICABLE ROBOT PLANNING

(71) Applicants: Yu Zhang, Tempe, AZ (US); Akkamahadevi Hanni, Tempe, AZ (US); Andrew Boateng, Phoenix, AZ (US)

(72) Inventors: Yu Zhang, Tempe, AZ (US); Akkamahadevi Hanni, Tempe, AZ (US); Andrew Boateng, Phoenix, AZ (US)

(73) Assignee: Arizona Board of Regents on Behalf of Arizona State University, Tempe, AZ (US)

(21) Appl. No.: 19/098,754

(22) Filed: Apr. 2, 2025

Related U.S. Application Data
(60) Provisional application No. 63/573,081, filed on Apr. 2, 2024.

(51) Int. Cl. B25J 9/16

(52) U.S. Cl. CPC B25J 9/163

(57) ABSTRACT

A computer-implemented system generates an optimal trajectory for completion of a task by a robot that merges robot-oriented behavior with human expectation. The system determines, based on task information and by iterative modification of one or more policy parameters of a policy descriptive of one or more task-oriented actions, one or more updated policy parameters of an updated policy descriptive of an updated set of task-oriented actions for completion of the task by the computer-implemented agent that: (a) satisfies a task constraint associated with the task and a safety constraint on a robot-oriented expected return value associated with a robot-oriented reward for the updated set of task-oriented actions; and (b) maximizes a human-oriented expected return value associated with a human-oriented reward for the updated set of task-oriented actions.

### CROSS-REFERENCE TO RELATED APPLICATIONS

This is a U.S. Non-Provisional Patent Application that claims benefit to U.S. Provisional Patent Application Ser. No. 63/573,081 filed Apr. 2, 2024, which is herein incorporated by reference in its entirety.

### GOVERNMENT SUPPORT

This invention was made with government support under 2047186 awarded by the National Science Foundation. The government has certain rights in the invention.

### FIELD

The present disclosure generally relates to policy generation for human-robot interaction, and in particular, to a policy generation method that generates behaviors for robots that are close to human expectations while satisfying the safety constraints introduced by the bound.

### BACKGROUND

AI and robotic agents are no longer confined to spaces of their own but are deployed in environments surrounded by humans. As robot capabilities improve, they are expected to assist or collaborate with humans. In such situations, it is important for the robot to generate behaviors that humans expect.

In explicable planning, the objective is to find a plan for robotic behavior that maximizes its similarity to a human expected plan. An important limitation of existing approaches for explicable planning is that they do not guarantee any bound on the suboptimality of the plan/policy found under the ground truth. In many situations, generating a human expected behavior may result in over-compromising the cost in the robot's model, i.e., resulting in unsafe behaviors.

It is with these observations in mind, among others, that various aspects of the present disclosure were conceived and developed.

### BRIEF DESCRIPTION OF THE DRAWINGS

The present patent or application file contains at least one drawing executed in color. Copies of this patent or patent application publication with color drawing(s) will be provided by the Office upon request and payment of the necessary fee.

FIGS. 1A and 1B are a pair of simplified diagrams showing a system for safe explicable trajectory planning for a computer-implemented agent (e.g., a robot).

FIGS. 2A-2C are a series of simplified diagrams showing a problem formulation (FIG. 2A) and relationships between different sets of policies for solving the problem in FIG. 2A, where FIG. 2B shows policy sets and FIG. 2C shows policy search for both Policy Descent Tree Search (“PDT”, Algorithm 1) and Policy Ascent Greedy Search (“PAG”, Algorithm 2) on a pruned-action space \tilde{Π} (where black nodes are expanded by PDT in descending order of state values under a robot-oriented model [symbol] _{R}, where blue nodes are expanded by PAF in ascending order under a human-oriented model [symbol] _{R}^{H}, and where solid lines represent single-action policy updates and dashed links represent multi-action updates.

FIGS. 3A-3D are a series of graphical representations showing comparison of behaviors (trajectories) of a virtual computer-implemented agent in a “wumpus world” illustration. Black lines show the trajectories of a “wumpus”. Red line segments show the parts of the agent's trajectories when the wumpus is in an adjacent cell, and green line segments show when the wumpus is at least two steps away. FIG. 3A shows a most likely trajectory under the optimal agent's policy (which is sub-optimal for the human), FIG. 3B shows a most likely trajectory under the human's expectation (which is sub-optimal for the agent), and the safe explicable policies obtained when δ=0.90 by PDT+ (FIG. 3C) and PAG+ (FIG. 3D).

FIGS. 4A-4C are a series of graphical representations showing comparison of behaviors (trajectories) of a virtual computer-implemented agent in a large “cliff world” illustrations. Grey areas indicate the cliff and G is the goal. Reward for each state is shown at the top right corner. Displayed are the most likely trajectories from policies: FIG. 4A shows the optimal policy under a robot-oriented model [symbol] _{R}, FIG. 4B shows the optimal policy under human-oriented model [symbol] _{R}^{H}, and FIG. 4C shows the safe explicable policies returned by PDT+ (green) and PAG+ (blue).

FIGS. 5A-5C are a series of graphical representations showing a Pareto set obtained by PDT+ when δ=0.90 and their corresponding V values in [symbol] _{R}^{H}, in the small cliff world. Values highlighted in red are those that result in non-dominated policies. FIG. 5B shows the policy obtained by PAG+.

FIGS. 6A and 6B are photograph sequences showing safe explicable behaviors generated by PAG+ in a robot assistant domain under different bounds (FIG. 6A on the “left-hand” side shows behaviors of the robot when safety bound δ=0.85; FIG. 6B on the “right-hand” side shows behaviors of the robot when safety bound δ=0.80).

FIG. 7A is a simplified illustration showing: (a) a car merging scenario showing the user expected behavior (left), the optimal behavior (middle), and a safe explicable behavior (right).

FIG. 7B is a simplified illustration showing a problem setting where an agent learns a surrogate reward function u_{H} that captures the user's expectations, which are generated from her belief of the agent's model [symbol] _{A}, represented as [symbol] _{A}. In a reinforcement learning setting, when the agent takes an action, it receives the agent's task reward [symbol] _{A}, the safety costs associated with a set of cost functions, [symbol] ᵢ, and the assumed surrogate reward u_{H} as user feedback. The agent approximates the expected returns for these costs and rewards while applying the quality d₀ and safety limits {dᵢ} to ensure that its policy is safe and efficient.

FIGS. 8A-8C are a series of graphical representations showing average performance over three runs for SEPS and baselines in PointGoal; the x-axis is training epoch; FIG. 8A shows returns under u_{H}, FIG. 8B shows returns under [symbol] _{A}, and FIG. 8C shows returns under [symbol] ₁.

FIGS. 9A-9C are a series of graphical representations showing average performance over three runs for SEPS and baselines in PointButton task over random seeds; the x-axis is training epoch; FIG. 9A shows returns under u_{H}, FIG. 9B shows returns under [symbol] _{A}, and FIG. 9C shows returns under [symbol] ₁.

FIGS. 10A and 10B are a pair of illustrations showing resulting trajectories of different methods in the two simulation domains; SEPS corresponds with blue lines, [symbol] _{A}/ [symbol] _{A}-CPO corresponds with red lines, u_{H}/u_{H}-CPO corresponds with orange lines, and EPS/EPS-CPO corresponds with green lines.

FIGS. 11A and 11B are photograph sequences showing a robot optimal behavior and a safe explicable behavior generated in a robot assistant domain (FIG. 11A on the “left-hand” side shows a robot-optimal trajectory [symbol] ; FIG. 11B on the “right-hand” side shows a safe explicable trajectory

$${τ}_{{ℳ}_{A}^{H}} ) .$$

FIGS. 12A and 12B are photograph sequences showing safe explicable behaviors generated in a robot assistant domain (FIG. 12A on the “left-hand” side shows a trajectory generated by EPS-CPO; FIG. 11B on the “right-hand” side shows a trajectory generated by SEPS).

Corresponding reference characters indicate corresponding elements among the view of the drawings. The headings used in the figures do not limit the scope of the claims.

### DETAILED DESCRIPTION

Systems and methods for safe explicable trajectory planning for a computer-implemented agent (e.g., a robot) are outlined herein.

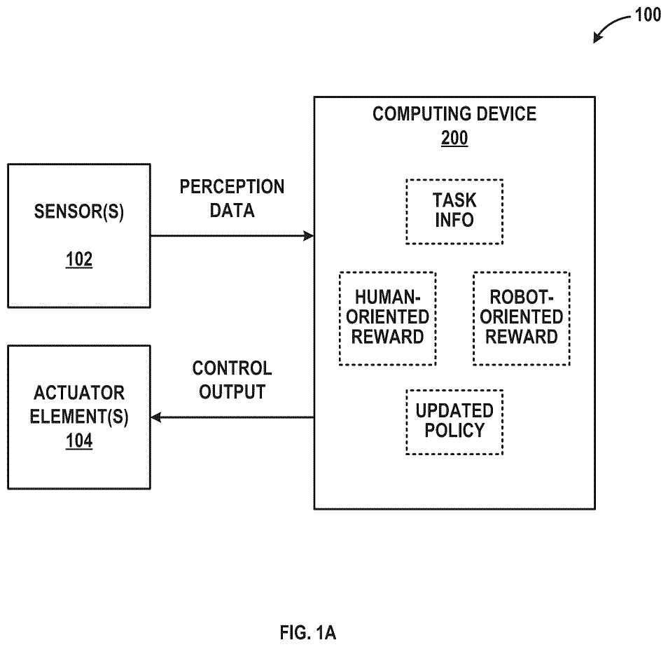

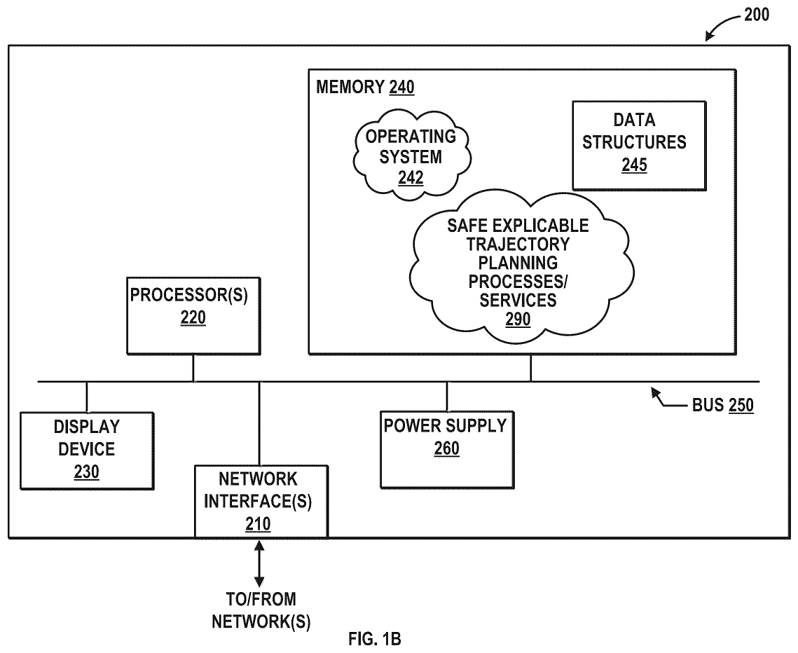

Referring to FIGS. 1A and 1B, a system 100 can include a computing device 200 that can communicate with one or more sensor device(s) 102 and one or more actuator element(s) 104 of a computer-implemented agent (e.g., a robot).

The computing device 200 can include a processor in communication with a memory, which can include instructions executable by the processor to: access task information about a task to be completed by a computer-implemented agent; and determine, based on the task information and by iterative modification of one or more policy parameters of a policy descriptive of one or more task-oriented actions, one or more updated policy parameters of an updated policy descriptive of an updated set of task-oriented actions for completion of the task by the computer-implemented agent that: (a) satisfies a task constraint associated with the task and a safety constraint on a robot-oriented expected return value associated with a robot-oriented reward for the updated set of task-oriented actions; and (b) maximizes a human-oriented expected return value associated with a human-oriented reward for the updated set of task-oriented actions. The memory can further include instructions executable by the processor to generate a control output (e.g., for application to the one or more actuator element(s) 104 or for otherwise controlling operation of the computer-implemented agent) for execution of the one or more task-oriented actions by the computer-implemented agent based on the updated policy with respect to the task information. To determine the policy parameters, the processor can apply Algorithm 1, Algorithm 2, or Algorithm 3 outlined herein.

The memory can also include instructions executable by the processor to access perception data captured by the one or more sensor device(s) 102 of the computer-implemented agent with respect to the task; and evaluate the policy with respect to the safety constraint and the task constraint based on the perception data.

FIG. 1B is a schematic block diagram of an example device 200 that may be used with one or more embodiments described herein, e.g., as a component of a robotic system (computer-implemented agent) for generating a trajectory defining one or more task-oriented actions based on a policy with respect to task information, including generating control inputs applied to actuator devices of the computer-implemented agent for execution of the one or more task-oriented actions based on the updated policy with respect to the task information.

Device 200 comprises one or more network interfaces 210 (e.g., wired, wireless, PLC, etc.), at least one processor 220, and a memory 240 interconnected by a system bus 250, as well as a power supply 260 (e.g., battery, plug-in, etc.). Device 200 can also include or otherwise communicate with a display interface device 230 which can include one or more input/output devices that enable a user or computer-implemented interfacing component to input data, and to view or otherwise access output data. Input/output devices can include but are not limited to a monitor, a touch-screen, a speaker, a keyboard, a mouse, and the like.

Network interface(s) 210 include the mechanical, electrical, and signaling circuitry for communicating data over the communication links coupled to a communication network. Network interfaces 210 are configured to transmit and/or receive data using a variety of different communication protocols. As illustrated, the box representing network interfaces 210 is shown for simplicity, and it is appreciated that such interfaces may represent different types of network connections such as wireless and wired (physical) connections. Network interfaces 210 are shown separately from power supply 260, however it is appreciated that the interfaces that support PLC protocols may communicate through power supply 260 and/or may be an integral component coupled to power supply 260. In some examples, device 200 may be implemented remotely from the computer-implemented agent.

Memory 240 includes a plurality of storage locations that are addressable by processor 220 and network interfaces 210 for storing software programs and data structures associated with the embodiments described herein. In some embodiments, device 200 may have limited memory or no memory (e.g., no memory for storage other than for programs/processes operating on the device and associated caches). Memory 240 can include instructions executable by the processor 220 that, when executed by the processor 220, cause the processor 220 to implement aspects of the system and the methods outlined herein, including Algorithm 1, Algorithm 2, and/or Algorithm 3. Memory 240 can be a non-transitory computer readable medium comprising instructions stored thereon, which, when executed, the instructions are effective to cause at least one processor 220 to implement aspects of the system and the methods outlined herein, including Algorithm 1, Algorithm 2, and/or Algorithm 3.

Processor 220 comprises hardware elements or logic adapted to execute the software programs (e.g., instructions) and manipulate data structures 245. An operating system 242, portions of which are typically resident in memory 240 and executed by the processor, functionally organizes device 200 by, inter alia, invoking operations in support of software processes and/or services executing on the device. These software processes and/or services may include Safe Explicable Trajectory Planning processes/services 290, which can include aspects of methods and/or implementations of various modules described herein. Note that while Safe Explicable Trajectory Planning processes/services 290 is illustrated in centralized memory 240, alternative embodiments provide for the process to be operated within the network interfaces 210, such as a component of a MAC layer, and/or as part of a distributed computing network environment.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules or engines configured to operate in accordance with the techniques herein (e.g., according to the functionality of a similar process). In this context, the term module and engine may be interchangeable. In general, the term module or engine refers to model or an organization of interrelated software components/functions. Further, while the Safe Explicable Trajectory Planning processes/services 290 is shown as a standalone process, those skilled in the art will appreciate that this process may be executed as a routine or module within other processes.

The present disclosure is outlined as follows: Section 1 outlines a first embodiment of a computer-implemented method for safe explicable trajectory planning (including Algorithms 1 and 2), and Section 2 outlines a second embodiment of a computer-implemented method for safe explicable trajectory planning that extends the first embodiment to operate in continuous stochastic environments (including Algorithm 3).

### 1. Safe Explicable Trajectory Planning

Significant strides have been made in advancing the capabilities of AI agents in recent years, from operating in isolated environments to being deployed in environments surrounded by humans. Examples of such agents include Starship's food delivery robots, Amazon's Astro household assistants, Bear Robotics' hospitality robots, and Waymo's autonomous vehicles, among many others. As technologies evolve, these AI agents are poised to become our indispensable partners. It is imperative for Alto learn from human-human interaction where aligning an agent's behavior with others' expectations is a key to such social interaction.

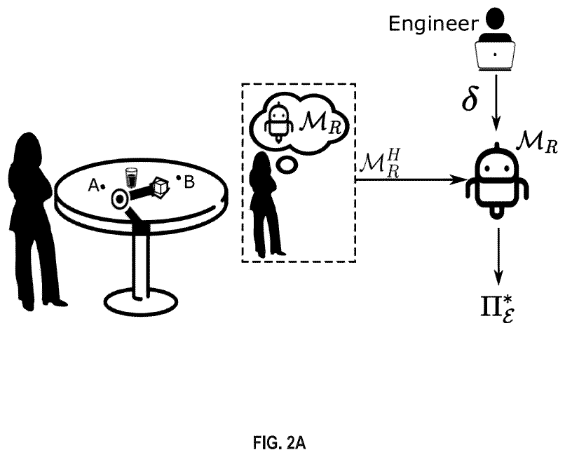

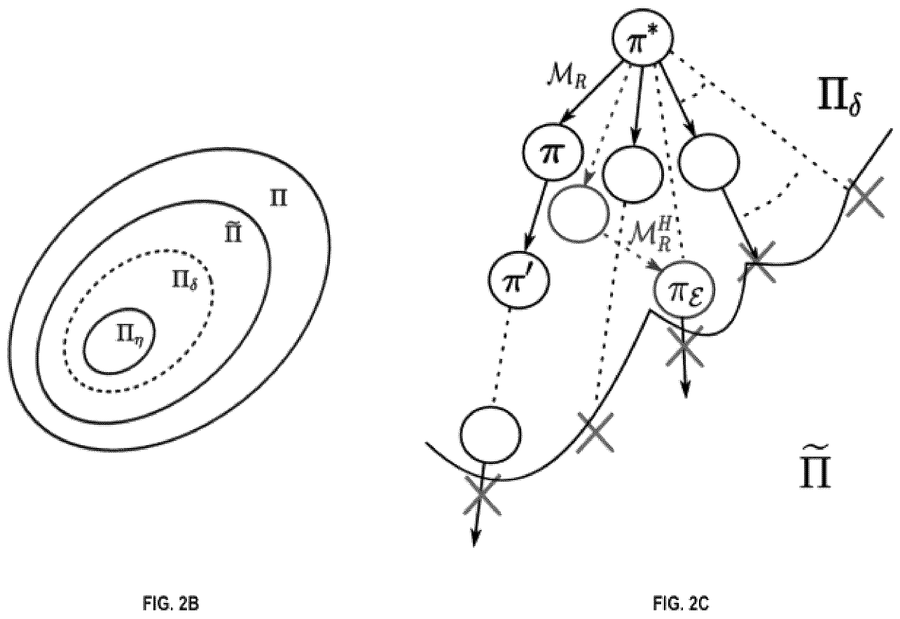

Explicable planning is an existing framework addressing human expectations in decision-making. It operates under the assumption that humans form their expectations of an agent's behavior based on their perception of the agent and the environment (M_{R}^{H}), which may deviate from the reality captured by the agent's model (M_{R}) (see FIG. 2A). In the original formulation, the objective is to find a plan that closely resembles the human's expected plan, as measured by an explicability metric, while simultaneously minimizing a plan cost metric through a linearly weighted sum of the two metrics. To address explicable behavior generation in stochastic domains, one method defines a similar objective within a learning framework under Markov Decision Processes (MDPs). However, a key drawback of these methods is the lack of consideration of a bound on the sub-optimality of the solution under the ground-truth model (i.e., M_{R}). This is due to the fact that the trade-off between cost and explicability metrics (at different scales) is governed by a hyper-parameter, referred to as the reconciliation factor. Consequently, generating an explicable behavior may overly compromise the cost in the ground-truth model, leading to potentially unsafe behaviors.

Let us further illustrate the need for safe explicable planning (SEP) via a motivating scenario. Imagine a human working alongside a robot manipulator. The task is for the robot to hand over a box to the human, with two potential locations for placement: ‘A’ and ‘B’ (depicted in FIG. 2A). Location ‘A’ is closer to the human but involves a small risk of tipping over a water cup nearby. When the cup is empty, this risk is negligible. In such cases, the preferred action would be for the robot to place the box at ‘A’ to align with the human's expectation. However, when the cup is not empty, tipping it over could lead to hazards like electric shocks that incur significant costs in the robot's model. Hence, the preferred action would be for the robot to place the box at ‘B’. When such a subtle difference (i.e., whether the cup is empty) is not apparent from the human's perspective (based on [symbol] _{R}^{H}), the robot may indistinguishably prioritize conforming to the human's expectations, leading to unsafe behavior despite seeming more explicable. In SEP, the robot's behaviors are constrained by a cost bound in the ground-truth model, ensuring it never chooses an unsafe behavior. SEP prioritizes safety without sacrificing explicability, which can mitigate the risk by preventing hazardous outcomes in human-robot interaction scenarios.

In our Safe Explicable Planning (SEP) approach, we build upon the following assumptions to focus on the planning challenges. First, we assume that the agent has access to its model ( [symbol] _{R}) and the human's belief of its model ( [symbol] _{R}^{H}), or simply, the human's model. A similar assumption has been made in prior research on explicable planning and explainable decision-making. In practice, the human's model may be provided by experts or acquired from human feedback, which has been explored in previous studies. Second, we assume that the human is a rational observer, i.e., a behavior with a higher expected return in the human's model is more expected. Hence, the most expected behavior can be generated by computing the optimal behavior in the human's model. This assumption allows us to equate the problem of maximizing explicability to maximizing the expected return of a policy under the human's model (that is modeled as an MDP). Such an assumption of human rationality is a common simplification in cognitive science and artificial intelligence research.

We formulate Safe Explicable Planning (SEP) under MDP by defining the objective as maximizing the expected return in the human's model, subject to a constraint in the agent's model. This problem formulation generalizes the consideration of multiple objectives to also consider multiple domain models. The solution to this problem yields a Pareto set of policies for which exact solvers are often intractable. To address this challenge, we propose an action-pruning technique to reduce the policy space significantly. Subsequently, we introduce a novel tree search method that efficiently explores the remaining policies to identify the Pareto set. We formally prove that this search method is sound and complete. Additionally, we introduce a greedy search method for situations where any policy from the Pareto set suffices. Finally, we devise approximate solutions for both search methods using state aggregation, addressing scalability in large domains. We evaluate our methods across several domains via simulation and physical robot experiments, demonstrating their effectiveness for SEP. Furthermore, we conduct ablation studies to analyze the benefits of our pruning techniques, validating their effectiveness in reducing computational costs while generating the desired behaviors.

### 1.1 Related Work

Interest in explainable decision-making has been growing with the aim of creating Al agents whose behaviors are understandable to humans. We may broadly classify methods in this area into two categories: those that generate interpretable behaviors (implicit methods) and those that communicate to explain behaviors (explicit methods). Our work belongs to the former category. Researchers have approached implicit methods for explainable decision-making from various but related perspectives, such as generating behaviors that are considered legible, predictable, transparent, explicable, etc. . . . Our work extends explicable planning by addressing a critical gap in applying such methods to real-world scenarios.

Our problem formulation of SEP shares some key features with the constrained-criterion-based formulation of safe reinforcement learning (RL), which is inherently a Constrained Markov Decision Process (CMDP). Similar problem formulations have been proposed for continuous spaces and applied to risk-bounded motion planning (Huang et al. 2019). In these prior works, safety is encoded by constraining the expected cost under some designated cost function while maximizing the agent's reward function under the same model. In SEP, similarly, safety is encoded by constraining the expected return under the agent's reward function. SEP operates under the assumption that safety directly correlates with the expected return in the agent's model, following the intuition that unsafe behaviors would result in low returns. Our formulation can readily accommodate a CMDP (with a single constraint) by aligning the two different models (except for the reward functions) and substituting the robot's reward function in the safety constraint with the cost function.

A distinctive challenge in formulating SEP under CMDP arises from the presence of two different MDP models. Specifically, besides featuring two different reward functions, we must explore a more general setting in SEP that also features two different domain dynamics and discount factors. This additional complexity makes the existing solution methods for CMDP inapplicable to SEP. Take, for instance, the linear programming (LP) based approach for CMDP. This method defines the LP objective using an occupation measure for different state-action pairs, which is a function of the transition model and the discount factor. However, when dealing with the two different models in SEP, applying the LP solution introduces discrepancies between the occupation measure utilized in the objective and that employed in the constraint. Consequently, resolving these two sets of variables is nontrivial. Similar arguments can be made about the other solution methods.

The objective considered in SEP also bears a similarity to that in Multi-Objective Markov Decision Processes (MOMDP), as SEP must consider the expected return under both the agent's and human's model. MOMDPs, introduced for multiple objectives under the same MDP), typically aim to optimize a vector of expected returns for those objectives to derive a Pareto set of policies or to derive a single policy through linear scalarization of those objectives. However, to handle different models, MOMDP methods must produce multiple vectors of expected returns, each derived for a different model due to the difference in domain dynamics. Optimizing these vectors simultaneously poses a significantly greater challenge than optimizing a single vector in traditional MOMDPs.

In lexicographic ordered MOMDPs, one objective is optimized before the other in a predefined order. However, despite the merits, these methods often focus on computational efficiency and do not guarantee the solution's optimality. In addition, it is unclear how to extend them to handle objectives under different models.

Previous studies have explored solving multiple MDPs, focusing on identifying a policy that maximizes a combined or weighted sum of objectives, thus reducing it to a single objective optimization problem. While these methods may appear comparable to ours, they can yield policies that breach safety bounds or exhibit poor quality in the hu-man's model. This drawback stems from their inability to explicitly account for safety constraints, a gap that we address in our work.

### 1.2 Problem Formulation

In safe explicable planning, there are two models at play: [symbol] _{R} and [symbol] _{R}^{H}. We formulate these models as discrete Markov Decision Processes (MDPs). An MDP is represented by a tuple [symbol] = [symbol] [symbol] , [symbol] , [symbol] , [symbol] , γ [symbol] where [symbol] is a set of states, [symbol] is a set of actions, [symbol] (s′|s, α) is a transition function, [symbol] is a reward function, and γ is a discount factor. We assume [symbol] _{R} and [symbol] _{R}^{H} share the same state space [symbol] and action space [symbol] , but differ in other parameters. Specifically, [symbol] _{R} incorporates the true domain dynamics [symbol] _{R}, the engineered reward function [symbol] _{R}, and the engineered discount factor γ_{R} whereas [symbol] _{R}^{H} incorporates the human's belief about the domain dynamics [symbol] _{R}^{H}, human's belief about the reward function [symbol] _{R}^{H}, and human's belief about the discount factor γ_{R}^{H}. This is reasonable when humans and AI agents coexist in a shared workspace and possess certain shared understanding of the environment. Relaxing such an assumption incurs separate technical challenges (e.g., hierarchical models) that will be deferred to future work.

We work with the set of all stationary deterministic policies Π, where ∀π∈Π, π: [symbol] [symbol] [symbol] . An agent's optimal policy maximizes the expected return in the agent's model and is given by π*=argmax_{π} [symbol] [Σₜ₌₀^{∞}γ_{R}^{t}r_{R}(t)]. We define a safe behavior as any behavior with a return within a bound of the agent's optimal return. Similar criteria have been used in safe RL (Garcia and Fernandez 2015; Moldovan and Abbeel 2012). More formally, a policy π is considered safe or feasible if its return satisfies the following condition:

$${𝔼}_{{𝒥}_{R}}^{π} [ {\sum }_{t = 0}^{∞} {γ}_{R}^{t} {r}_{R} ( t ) ] \geq {δ𝔼}_{{𝒥}_{R}}^{π *} [ {\sum }_{t = 0}^{∞} {γ}_{R}^{t} {r}_{R} ( t ) ] , \qquad ( 1 )$$

where δ∈(0, 1] is the designer-specified safety bound. Since execution may start from any state, we require such a condition to hold true under any state. It also implies that the condition would hold from any step during execution. These are desirable features of safety critical systems.

In prior work on explicable planning, the objective is to maximize a weighted sum of the return in the agent's model and an explicability metric. Explicability metric has been defined, for example, via plan distances (Kulkarni et al. 2016) in deterministic domains and KL divergence between trajectory distributions (Gong and Zhang 2022) in stochastic domains. In our work, we define the explicability metric simply as the return in the human's model [symbol] _{R}^{H}. Given that the human user generates expectations from [symbol] _{R}^{H}, this assumes a rational human observer: the higher the return in the hu-man's model, the more expected the policy is.

Definition 1. Safe Explicable Planning (SEP), given by [symbol] = [symbol] [symbol] _{R}, [symbol] _{R}^{H}, δ [symbol] , is the problem to search for a policy that maximizes the return in [symbol] _{R}^{H} subject to a constraint on the return in [symbol] _{R} under any state, or formally:

$${π}_{ε}^{*} = arg {max}_{π} {𝔼}_{{𝒯}_{R}^{H}}^{π} [ {\sum }_{t = 0}^{∞} {γ}_{R}^{{H}^{t}} {r}_{R}^{H} ( t ) ] subject to \qquad ( 2 )$$

$${𝔼}_{{𝒯}_{R}}^{π} [ {\sum }_{t = 0}^{∞} {γ}_{R}^{t} {r}_{R} ( t ) ] \geq δ {𝔼}_{{𝒯}_{R}}^{{π}^{*}} [ {\sum }_{t = 0}^{∞} {γ}_{R}^{t} {r}_{R} ( t ) ] .$$

The maximization of the expected return above across all states introduces a Pareto set of optimal policies where no policies in this set are strictly dominated by any feasible policy. Briefly, a policy π₁ strictly dominates another policy π₂ if its state values are no smaller in any state, and larger in at least one state. Formally, we denote such a relationship as π₁ [symbol] π₂, which holds if

$$∀ s ∈ 𝒮 [ {V}_{{M}_{R}^{H}}^{{π}_{1}} ( s ) \geq {V}_{{M}_{R}^{H}}^{{π}_{2}} ( s ) ] ∧ {∃}_{s}^{′} ∈ 𝒮 [ {V}_{{M}_{R}^{H}}^{{π}_{1}} ( {s}^{′} ) > {V}_{{M}_{R}^{H}}^{{π}_{2}} ( {s}^{′} ) ] .$$

The Pareto set Π*_{ε}is then given by:

$${Π}_{ε}^{*} = \{ {π}_{ε}^{*} ∈ {Π}_{δ} \vert ¬ ∃ π ∈ {Π}_{δ} [ π ≻ {π}_{ε}^{*} ] \} , \qquad ( 3 )$$

where Π₆₇ ={π∈Π|∀s ∈ [symbol] [ [symbol] (s)≥δ [symbol] (s)]} is the set of policies that satisfy the safety bound.

### 1.3 Safe Explicable Trajectory Planning Solution: PDT and PAG

In this section, we motivate and discuss our solution methods for SEP. Given the large policy space to search for, we first discuss a technique to reduce the policy space. Since any policy Π_{δ}may be in the Pareto set, it necessitates the expansion of all policies in Π_{δ}. We propose an exact method that selectively expands policies in Π_{δ}to determine the Pareto set Π*_{ε}. Additionally, we discuss a greedy method that expands only a subset of policies in Π_{δ}, returning a single policy in Π*_{ε}. Finally, we propose approximate solutions via state aggregation, using handcrafted features, to condition similar states to choose the same actions to further scalability in large domains.

### 1.3.1 Policy Space Reduction via Action Pruning

Even though the set Π_{δ}cannot be obtained directly from the entire policy space Π, we aim to reduce the policy space based on the safety constraint to produce a subset of policies in Π, referred to as \tilde{Π}. The challenge here is to ensure that \tilde{⊇}Π_{δ}(see FIG. 2B).

We achieve this by pruning sub-optimal actions for every state that are guaranteed to violate the constraint. Specifically, let [symbol] (s) be the set of all actions that are available in any state s. The set of actions after pruning is given by:

$$\tilde{𝒜} ( s ) = \{ a ∈ 𝒜 ( s ) \vert {Q}_{{M}_{R}}^{{π}^{*}} ( s , a ) \geq δ {max}_{{a}^{′} ∈ 𝒜 ( s )} {Q}_{{M}_{R}}^{{π}^{*}} ( s , {a}^{′} ) \} \qquad ( 4 )$$

The policy space obtained from the resulting actions in all states is \tilde{Π}. Our action pruning technique draws inspiration from (Wray, Zilberstein, and Mouaddib 2015). In their work, to provide a worst-case guarantee under [symbol] _{R}, the authors employ 1−(1−γ)(1−δ) instead of δ in Eqn. (4), resulting in a different set of policies, denoted by [symbol] . Their pruning condition is more stringent than ours and may result in pruning actions prescribed by certain policies that satisfy the constraint in Eqn. (2). Consequently, the guarantee that [symbol] ⊇Π_{δ} is lost there (see 2B).

Lemma 1. The set of policies after pruning actions based on Eqn. (4) is a superset of the set of policies that satisfy the constraint in Eqn. (2), i.e., \tilde{Π}⊇Π_{δ}.

Proof Sketch: To prove this result, we show that an action pruned in a state per Eqn. (4) is guaranteed to introduce policies that violate the constraint in Eqn. (2) in at least one state. Then, we show the expected return of choosing a pruned action once (in the state it was pruned) and following the optimal policy thereafter, violates the constraint. Hence, any policy that chooses the pruned action for that state will result in violating the constraint.

### 1.3.2 Policy Descent Tree Search (PDT)

To determine Π*_{ε}, intuitively, we can evaluate every policy in \tilde{Π}. However, this would be impractical and proves to be unnecessary. A more efficient strategy involves further reducing \tilde{Π} by expanding policies in a specific order. There are two possible search strategies to explore. First, consider initializing the search to the optimal policy in the human's model and perform policy improvement under the agent's objective until the bound is satisfied. Alternatively, consider initializing the search to the optimal policy in the agent's model and perform policy decrement under the agent's objective while simultaneously identifying better policies under the human's objective, until the bound is violated. While the first search strategy is simpler it can lead to missed policies in Π*_{ε}, hence we choose the latter option in our work.

In tree search, we start from an optimal policy in [symbol] _{R}, denoted by π*, as the root node. The benefit of doing so is that, first, we already know that π* satisfies the bound under the agent's model as it is the optimal policy in [symbol] _{R}. Second, we can leverage the known state values [symbol] , to expand policies that have lower state values than that of the parent node, recursively. Since this is the opposite of policy improvement, we refer to it as policy descent. Formally, all descendants of a policy It under single-action policy updates in PDT can be obtained by replacing π(s) under any state s with an action a that satisfies:

$${Q}_{{M}_{R}}^{π} ( s , a ) \leq {Q}_{{M}_{R}}^{π} ( s , π ( s ) ) . \qquad ( 5 )$$

Once a branch reaches a policy whose state values no longer satisfy the bound in [symbol] _{R} (any state suffices), it is pruned as illustrated in FIG. 2C. The search continues until all branches are explored or pruned while the set of non-dominated policies in [symbol] _{R}^{H} are maintained. The algorithm is presented in Alg. 1, which we refer to as PDT+ (includes action pruning). Next, we formally show that such a process returns the Pareto set Π_{ε}=Π*_{ε}.

Lemma 2. Let π and π′ be two deterministic policies that differ only by a single action in some state i.e., as; ∃sᵢ∈ [symbol] [π′(sᵢ)≠π(sᵢ)]Λ∀sⱼ∈ [symbol] \{sᵢ}[π′(sⱼ)=π(sⱼ)] and satisfy [symbol] (sᵢ, π′(sᵢ))≤ [symbol] (sᵢ). Then, policy π′ is a descendant of π in PDT, i.e., policy π′ is no better than π, or formany,

$$∀ s ∈ 𝒮 [ {V}_{{M}_{R}}^{{π}^{l}} ( s ) \leq {V}_{{M}_{R}}^{π} ( s ) ] .$$

Algorithm 1: PDT+

Input: [symbol] _{R}, [symbol] _{R}^{H} ,δ [symbol]
← ValueIteration(M_{R}); retrieve π
Compute [symbol] (s), ∀s ∈ S;
Initialize Π_{ε} ← Ø; fringe. push(π*);
while fringe ≠ Ø do

| \| | π ← fringe. pop( ); | | | | |
|---|---|---|---|---|---|
| \| | for a in [symbol] (s), s ∈ S do | | | | |
| \| | \| | if Eqn. (5) is satisfied then | | | |
| \| | \| | \| | π′ ← Modify(π, π(s) = a); | | |
| \| | \| | \| | if ∀s ∈ S [ [symbol] (s) ≥ δ [symbol] (s)] then | | |
| \| | \| | \| | \| | fringe. push(π′); | |
| \| | \| | \| | \| | if nonDominated(π′, Π_{ε}, [symbol] _{R}^{H}) then | |
| \| | \| | \| | \| | \| | Π_{ε}. update(π′); |

return Π_{ε}

Proof Sketch: This is an extension of the policy improvement theorem (Sutton and Barto 2018) but in the opposite direction (hence referred to as a policy descent step). First, we introduce a temporary non-stationary policy π′₁ that chooses an action as per π′ under the initial state and follows π thereafter. We can show that the return of π′₁ is no better than that of π. We can repeat such a pattern to update π′₁ for the next state and so on, resulting in π′ at the end.

Similarly, we can show that a special case of the policy improvement theorem holds when a single action is updated (referred to as a policy ascent step).

Theorem 1. PDT+ returns all Pareto optimal policies in Π*_{ε}.

Proof Sketch: To prove this, we show that there exists a policy descent path from any optimal policy (denoted by π*) in [symbol] _{R} (i.e., the root node in PDT) to any Pareto optimal policy (denoted by π*_{ε}) in Π*_{ε}by induction. When π*_{ε}differs from π* in only 1 action, it must be one of the direct descendants of π* in PDT as π* is the optimal policy in [symbol] _{R}. Hence, π*_{ε}will be expanded by PDT. Assume any policy that differs from π* in k actions is expanded. When π*_{ε}differs from π* in k+1 actions, we show that there must exist a policy π that differs from π* in k out of the k+1 actions (hence differing from it; in 1 action) and (by Lem. 2) is no worse than π*_{ε}under [symbol] _{R} via proof by contradiction. Consequently, π*_{ε}must be a descendant of π in PDT. Since π is expanded under our inductive assumption, π*_{ε}will be expanded. Then by Lem. 1, the conclusion holds.

### 1.3.3 Policy Ascent Greedy Search (PAG)

In certain situations, it may be unnecessary to compute Π*_{ε}any policy in the set would suffice. To this end, we introduce a greedy method that only searches through a subset of Π_{δ}, making it computationally more efficient than PDT.

Algorithm 2: PAG+

```
Input: [symbol]   _{R}, [symbol]   _{R}^{H} ,δ [symbol]
← ValueIteration(M_{R}); retrieve π*
Compute [symbol]   (s), ∀s ∈ S;
Initialize π_{ε} ← π*; changed ← true;
while changed do [symbol]
  ← PolicyEvaluation(π_{ε}, [symbol]   _{R}^{H})
  changed ← false
  for a in [symbol]   (s), s ∈ S do
    if Eqn. (6) is satisfied then
      π′ ← Modify(π_{ε}, π_{ε}(s) = a);
      if ∀s ∈ S [ [symbol]   (s) ≥ δ [symbol]   (s)] then
        Update π_{ε} ← π′
        changed ← true
return π_{ε}
```

Similar to PDT, we start with π* at the root node. However, unlike in PDT where we expand policies that have lower state values in [symbol] _{R} via single-action policy updates, we expand only a single policy that has higher values in [symbol] _{R}^{H} than its parent node via multi-action policy updates (see FIG. 2B). Formally, only one descendant of policy π is expanded in PAG, which is obtained by replacing π(s) under each state s with an action α that satisfies the following condition (similar to a policy improvement step):

$${Q}_{{M}_{R}^{H}}^{π} ( s , a ) \geq {Q}_{{M}_{R}^{H}}^{π} ( s , π ( s ) ) , \qquad ( 6 )$$

where each such state-action update is checked against the constraint in Eqn. (2) (in [symbol] _{R}) incrementally and incorporated only if the constraint is not violated, resulting in a multi-action policy update for

$${V}_{{M}_{R}^{H}}^{π} .$$

In PAG, we maintain a single candidate policy π_{ε} as opposed to a set in PDT. The current policy π_{ε} is updated to its descendant π′ if at least one of the state-action updates is incorporated. This process is repeated until π_{ε} remains unchanged. The algorithm, referred to as PAG+ (includes action pruning), is presented in Alg. 2.

Theorem 2. PAG+ returns a policy in the Pareto set Π*_{ε}.

Proof Sketch: The PAG search process stops when it can no longer improve or find a policy that is equivalent in values to π_{ε} under [symbol] _{R}^{H} while satisfying the safety constraint. This implies that there does not exist a state-action update that implements a policy ascent step under the constraint. However, if π_{ε}∉Π*_{ε}, there must exist another policy π∈Π*_{ε} that dominates π_{ε}, which contradicts with the fact that no policy ascent step exists. Then by Lem. 1, π_{ε}∈Π*_{ε}.

### 1.3.4 Approximate Solution via State Aggregation

In the worst-case scenario, both PDT+ and PAG+ must explore a number of policies on the order of |\tilde{Π}|, which remains exponential. Consequently, directly applying these methods to complex domains proves challenging. Approximate solutions become essential. However, conventional methods relying on function approximation for state value functions to search for optimal policies (Sy'kora 2008; Abel, Hershkowitz, and Littman 2016; Abel et al. 2018; Ferrer-Mestres et al. 2020) are not applicable here, as the search is conducted over the policy space.

We aim to devise an approximate solution that minimizes the number of unique policies to be explored. Inspired by function approximation, one approach is to condense the state space by grouping together states that exhibit similar action selection tendencies. The similarity of states can be measured using domain-specific features. By conditioning states within the same clusters to select the same actions under any policy with either model, we effectively reduce the state space size and consequently the number of policies. Formally, this process involves introducing a mapping Φ: [symbol] _{K} [symbol] [symbol] , establishing a one-to-many correspondence from clusters to states, where K denotes the number of clusters. Both PDT and PAG can operate using the aggregated state space (i.e., clusters), treating [symbol] _{K} as the new state space.

Under the assumption that the states within any cluster are “correlated” in action selection under any given policy, the theoretical guarantees of optimality, completeness, and constraint satisfaction remain intact. Such a situation may occur, for example, when two states are topologically equivalent, such that a reasonable policy should always choose the same action under these states. Investigating the introduction of such states and their impact on guarantees when this assumption does not hold or holds only approximately would be interesting. From this perspective, our approximation method resembles function approximation in Q-learning.

### 1.4 Evaluation

We evaluate our methods across various domains through simulation and physical robot experiments, aiming to achieve three main objectives. First, we compare safe explicable behaviors with optimal behaviors to validate the efficacy of our approach. Second, given that solving SEP involves searching for the optimal policy in the feasible policy space to obtain the Pareto set, we evaluate the efficiency of our proposed methods and compare them with baselines (BF & BF+) that employ brute-force policy search. Notably, our comparisons are against brute-force methods because prior studies discussed in the related work section lack consideration for multiple models or safety bounds (refer to related work). Additionally, we conduct ablation studies for each proposed method to analyze the benefits of pruning actions and our approximate solutions in more complex domains. Third, we conduct physical robot experiments to demonstrate the applicability of our approach to real-world scenarios. Following our naming convention, we append ‘+’ to an algorithm's name to denote the incorporation of our action pruning technique, resulting in a reduced policy space \tilde{Π}; a method without ‘+’ must search the original policy space, or Π (refer to FIG. 2B). All evaluations were run on a Mac-Book Pro (16 GB, 3.1 GHZ Dual-Core Intel Core i5).

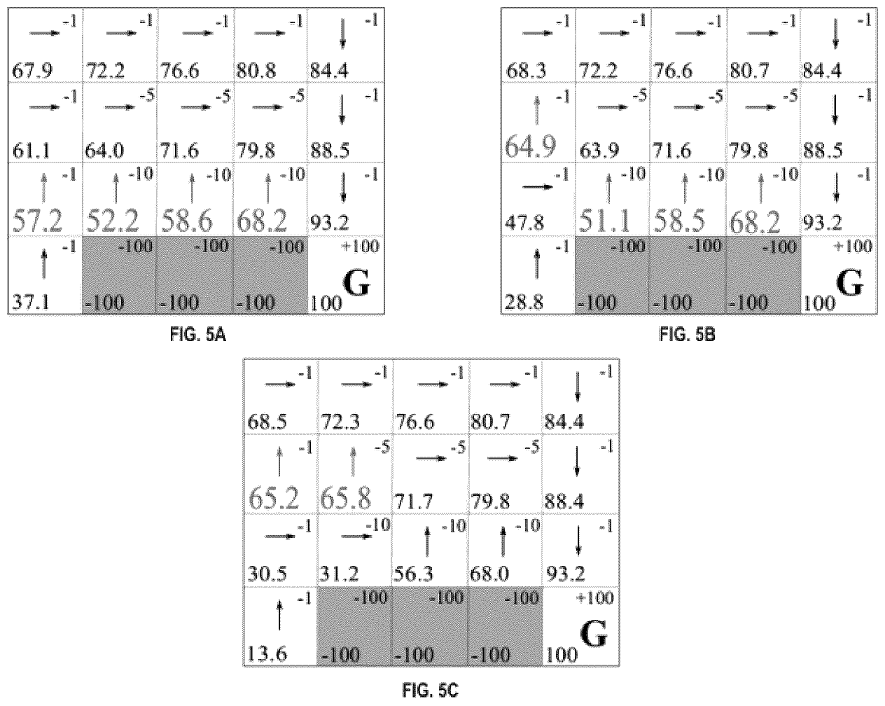

Bound Selection: In our approach, we assume the bound is specified by the designer, based on experience. However, it can often be estimated based on the domain. For instance, consider one of the cliff worlds depicted in FIGS. 5A-5C. The optimal return in the agent's model is 94 (i.e., moving along the edge of the cliff to the goal), while the return of the trajectory with the longest detour (i.e., staying as far away from the edge as possible) without falling off the cliff is 90, discount notwithstanding. As unsafe behaviors yield significantly lower returns (in [symbol] _{R}) than the detour, the safety bound can be set to 90/94=0.957, subject to adjustment. Further analyses will be deferred to future work.

Policy Selection: User preferences can serve as a guiding factor to select from the Pareto set Π*_{ε}. Alternatively, domain-specific scores may be introduced to aid in the selection process. For instance, policies that are deemed “simpler” may receive higher scores. Example scores are discussed below, wherever applicable.

### 1.4.1 Simulations

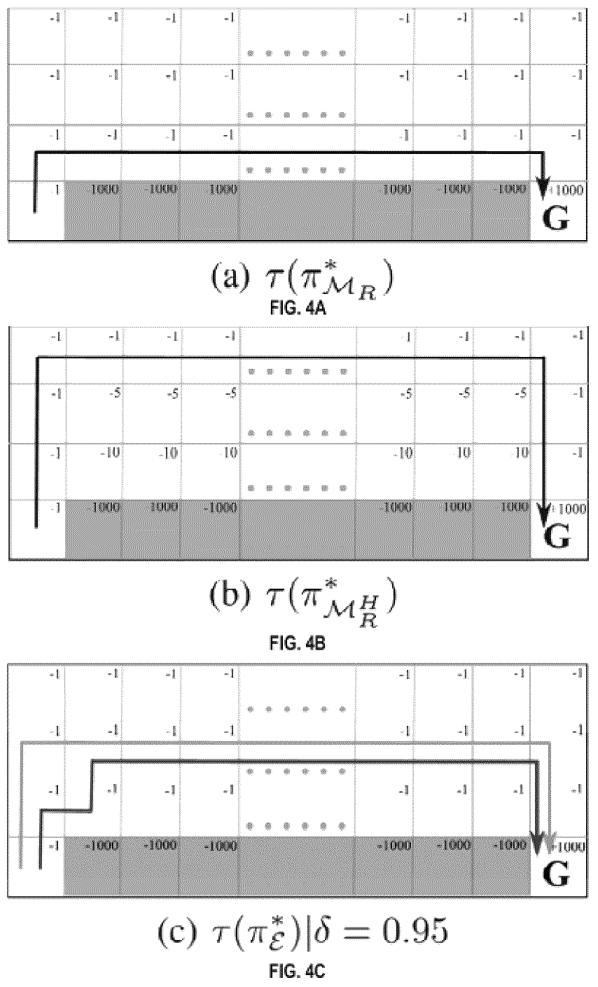

Domain Descriptions: 1) Cliff Worlds (CS & CL): The task entails navigating alongside the edge of a cliff to reach the goal, as depicted in FIGS. 4A-4C and 5A-5C. The ground-truth ( [symbol] _{R}) is that the agent can travel alongside the edge without slipping off the cliff. Conversely, the human's belief ( [symbol] _{R}) is that there is a probability that the agent may slip off from the edge, especially in terrain closer to the cliff, which is more uneven and challenging to traverse. Both models have similarly defined reward functions, [symbol] _{R} and [symbol] _{R}^{H}, shown in FIGS. 4A and 4B, respectively, for the larger domain. We designed a small 4×5 domain (CS) for the exact methods and a large 4×100 domain (CL) for approximate solutions. To apply approximate solutions to CL, we aggregated all non-terminal states based on features such as distance to the cliff and the agent's position in the grid (e.g., along the edge or at the ends) into 10 clusters while retaining the terminal states as they are.

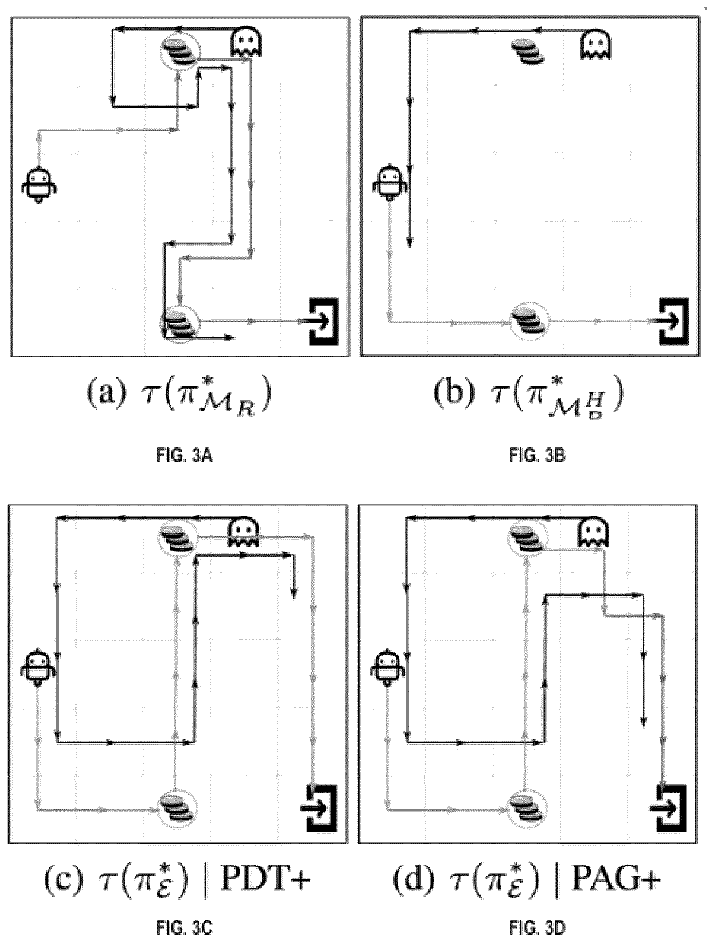

2) Wumpus World (W): The agent's objective is to exit a 5×5 cave while collecting gold coins and avoiding encounters with the wumpus (i.e., entering the same location as the wumpus) (see FIGS. 3A-3D). The wumpus always moves towards the agent. Each collected gold coin yields a reward of +30, and the game ends if the agent encounters the wumpus (−100) or exits the cave (+100). The ground-truth ( [symbol] _{R}) is that the agent's actions are deterministic, whereas the wumpus's actions are stochastic. Conversely, the human's belief ( [symbol] _{R}^{H}) is that both agents' actions are stochastic. Under this belief, the human perceives it as risky for the agent to approach the wumpus. For approximate solutions, non-terminal states were aggregated into 15 clusters based on features such as the relative direction of the wumpus from the agent and collected gold coin(s).

Results: 1) Performance Comparison: Table 1 presents the runtime (except for BF and BF+ due to the large number of policies) and the number of policies expanded (or evaluated) by each method across the three simulation domains. The small cliff world (CS) comprises 16 non-terminal states and 4 actions in each state, resulting in |Π|=4¹⁶ policies. The large cliff world (CL) comprises 301 non-terminal states and 4 actions in each state, resulting in |Π|=4³⁰¹ policies, but upon aggregation, it reduces to 4¹⁰ policies. The wumpus world (W) comprises 2116 non-terminal states and 4 actions in every state, resulting in |ε|=4²¹¹⁶ policies, but upon aggregation, it reduces to 4¹⁵ policies. We employ approximate solutions (i.e., PDTs and PAGs on aggregated state space) on CL and W.

We observe that action pruning effectively reduces the policy space and consequently the number of policies expanded by BF+, PDT+, and PAG+ compared to BF, PDT, and PAG, respectively. The expansion order of policies in PDTs leads to significant additional reduction compared to BF+. With or without action pruning, PAGs expand fewer policies than PDTs as they only need to return a single policy. Lastly, although the number of policies expanded in PDTs increases (for lower δ), it is worth noting that PAGs sometimes expand fewer policies due to their greedy nature.

TABLE 1
Comparison of different methods via the number of policies evaluated
(#) and runtime (RT) in minutes. Numbers with a dot are approximate.

| | | BF | BF+ | PDT | | PDT+ | | | PAG | | PAG+ | |
|---|---|---|---|---|---|---|---|---|---|---|---|---|
| | δ | # | # | # | RT | # | RT | \|Π\|*_{ε} | # | RT | # | RT |
| CS | 1.00 | 4¹⁶ | 4⁴ | 8448 | 4.8 | 256 | 0.3 | 1 | 17 | 0.01 | 9 | 0.01 |
| | 0.95 | 4¹⁶ | \dot{4}⁹ | 8448 | 4.8 | 2816 | 1.7 | 1 | 17 | 0.01 | 10 | 0.01 |
| | 0.93 | 4¹⁶ | \dot{4}¹⁵ | 8448 | 4.8 | 7424 | 4.3 | 1 | 17 | 0.01 | 17 | 0.01 |
| | 0.90 | 4¹⁶ | \dot{4}¹⁵ | 16\dot{9}k | 102.2 | 14\dot{9}k | 90.3 | 3 | 21 | 0.02 | 19 | 0.01 |
| | 0.85 | 4¹⁶ | \dot{4}¹⁵ | 31\dot{3}k | 184.4 | 27\dot{4}k | 164.2 | 3 | 19 | 0.01 | 19 | 0.01 |
| CL | 1.00 | 4¹⁰ | 4² | 368 | 5.0 | 16 | 0.5 | 1 | 36 | 0.5 | 5 | 0.1 |
| | 0.97 | 4¹⁰ | \dot{4}⁹ | 684 | 7.9 | 620 | 7.1 | 1 | 36 | 0.5 | 32 | 0.4 |
| | 0.95 | 4¹⁰ | \dot{4}⁹ | 1846 | 21.0 | 1677 | 18.2 | 3 | 33 | 0.5 | 30 | 0.4 |
| | 0.93 | 4¹⁰ | \dot{4}⁹ | 2254 | 25.1 | 2048 | 22.8 | 2 | 30 | 0.4 | 27 | 0.4 |
| | 0.90 | 4¹⁰ | \dot{4}⁹ | 2268 | 25.4 | 2060 | 25.0 | 2 | 30 | 0.5 | 27 | 0.4 |
| W | 1.00 | 4¹⁵ | 4⁰ | 61 | 0.9 | 1 | 0.1 | 1 | 25 | 0.4 | 1 | 0.1 |
| | 0.97 | 4¹⁵ | \dot{4}¹ | 61 | 0.9 | 3 | 0.1 | 1 | 25 | 0.4 | 1 | 0.1 |
| | 0.95 | 4¹⁵ | \dot{4}⁵ | 61 | 0.9 | 13 | 0.3 | 1 | 25 | 0.45 | | 0.1 |
| | 0.93 | 4¹⁵ | \dot{4}⁵ | 1489 | 21.7 | 179 | 4.1 | 25 | 46 | 0.7 | 5 | 0.2 |
| | 0.90 | 4¹⁵ | \dot{4}⁵ | 2\dot{4}k | 359.1 | 729 | 42.1 | 197 | 46 | 0.7 | 5 | 0.2 |

Table 1: Comparison of different methods via the number of policies evaluated (#) and runtime (RT) in minutes. Numbers with a dot are approximate.

2) Behavior Comparison in Cliff Worlds: The results of the cliff worlds are shown in FIGS. 4A-4C and 5A-5C, with FIGS. 4A-4C corresponding with a large cliff world (CL), and FIGS. 5A-5C corresponding with a small cliff world (CS). Both the small and large domains introduce similar behaviors (shown only in the large domain): the optimal behavior in the agent's model takes the shortest path (FIGS. 4A-4C), whereas that in the human's model stays as far away from the cliff as possible (FIG. 4B). For SEP, FIGS. 5A-5C show all the three policies in the Pareto set obtained given δ=0.90 in the small domain. FIG. 4C shows the most likely trajectories resulting from the policies in the Pareto set obtained given δ=0.95 in the large domain using the approximate solution. In general, we observe that the safe explicable policies result in trajectories that steer the agent away but not too far from the cliff to satisfy the bound while aligning with the human's expectation. In cliff worlds, to choose from Π*_{ε}, we assign higher scores to policies producing simpler behaviors (e.g., fewer turns), it led to choosing the policy producing the green trajectory in FIG. 4C and the policy in FIG. 5A. PAGs, on the other hand, computed different policies in Π*_{ε}.

3) Behavior Comparison in Wumpus World: The results are shown in FIGS. 3A-3D. Following the optimal policy in the agent's model ( [symbol] _{R}), the agent collected both coins while staying near the wumpus before exiting, as shown in FIG. 3A. Following the optimal policy in the human's model ( [symbol] _{R}^{H}), the agent avoided getting close to the wumpus and collected a single coin before exiting, as shown in FIG. 3B. When applying SEP under the bound δ=0.90, PDT+ returns a large Pareto set (see Tab. 1). To select from Π*_{ε}, we score policies based on the average distance between the agent and the wumpus throughout the most likely trajectory. The trajectory from the policy with the highest score is shown in FIG. 3C: we can observe that the agent managed to collect both coins while maintaining a cautious distance from the wumpus, albeit taking a longer path, which is more explicable than the agent's optimal behavior in FIG. 3A and simultaneously more efficient than the human's expectation in FIG. 3B. FIG. 3D showcases the behavior obtained by PAG+, which also maintains a cautious distance from the wumpus, for the most part.

### 1.4.2 Physical Robot Experiment

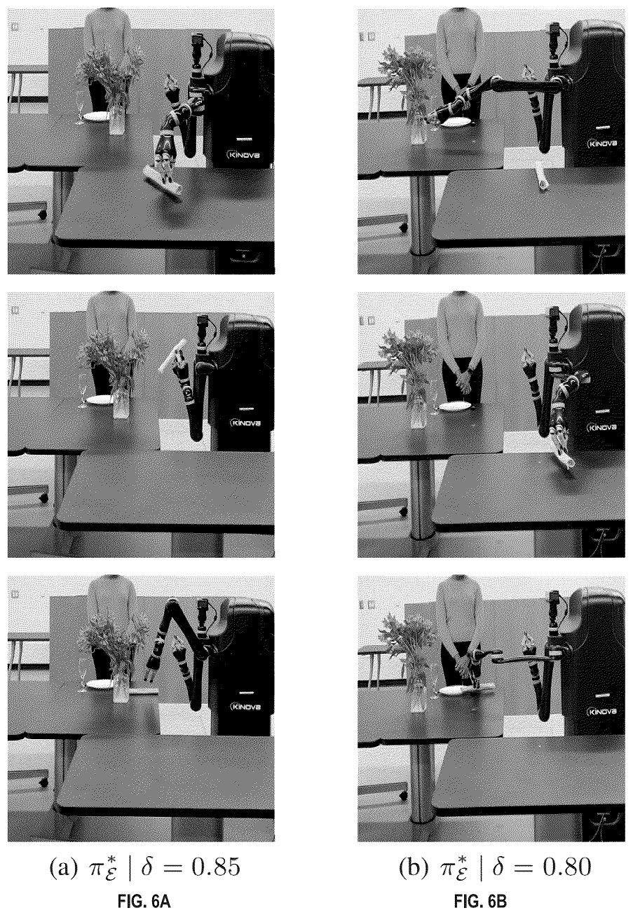

Robot Assistant Domain: We implemented a scenario similar to the motivating example, where a MOVO robot assists a human user in setting up the dining table (FIGS. 6A and 6B). The task involves fetching a napkin for the user from another table. However, the user lacks a full understanding of the kinematic constraints of the robot arms, expecting the robot to reach any location within its arm's length. Consequently, the user anticipates that the robot will place the napkin beside the plate, close to her. In contrast, the robot's model accounts for restricted arm movement due to a vase on the table. Placing the napkin close to the user may risk tipping over the vase containing water, posing a safety hazard. Therefore, the robot's optimal behavior dictates placing the napkin next to the vase, albeit farther away from the user.

In this experiment, we operated within a discretized environment where the state space was defined by the following variables: the robot's location, the napkin's location, and the vase's location. Transitions between discrete states were facilitated by pre-generated robot trajectories using Move It. Specifically, in [symbol] _{R} ^{H} the robot can access any location on the dining table regardless of its own position or the vase's placement, whereas [symbol] _{R} accurately reflects the influences from these factors. Our objective is to showcase that a robot operating under SEP would opt for a costlier policy in [symbol] _{R} to align with human expectations while ensuring safety.

Results: FIGS. 6A and 6B depict the safe explicable behaviors obtained from the robot experiment. The optimal behavior in [symbol] _{R} had two steps: the robot picked the napkin and placed it on the table next to the vase, away from the user. Further, we ran SEP with two different bounds, yielding two distinct safe explicable behaviors. When δ=0.85 (FIG. 6A), the robot picked the napkin, circumvented the obstruction by the vase by moving its entire base closer to the user and then placed the napkin next to the plate. When δ=0.80 (FIG. 6B), the robot initially moved the vase away to clear the obstruction, then picked the napkin and placed it next to the plate.

### 1.5 Conclusions

In this section, we introduced an initial formulation and solution to the Safe Explicable Planning (SEP) problem, an extension of the explicable planning problem to support a safety bound. Our formulation generalizes the consideration of multiple objectives that are addressed in conventional MOMDPs or CMDPs to multiple models. The solution to SEP is a safe explicable policy that satisfies the safety bound while maximizing explicability. We proposed an action pruning technique to reduce the search space, an exact method to find the Pareto set of policies, and a greedy method to find a single policy in the Pareto set. We discussed approximate solutions through state aggregation based on state features and action choices to address scalability. However, our methods are still susceptible to policy explosion in complex domains our approach shows initial steps towards finding approximate safe explicable policies, with further research needed for more generalized and efficient approximation solutions. We conducted evaluations via simulations and physical robot experiments to validate the efficacy of our approach.

### 1.6 Proofs and Domain Descriptions for Safe Explicable Planning

First, the complete proofs for Lemma. 1, Lemma. 2, Theorem 1, and Theorem 2 are presented in section 1.6.1. Second, the domain descriptions for the small cliff world (CS), large cliff world (CL), wumpus world (W), and the physical robot experiments are presented. Lastly, additional discussions and conclusions are presented.

### 1.6.1 Proofs

Lemma 1. The set of policies after action pruning based on Eqn. (4) is a superset of the set of policies that satisfy the constraint in Eqn. (2), i.e., \tilde{Π}⊇Π_{δ}.

Proof. To prove this we show that an action pruned by any state per Eqn. (4) is guaranteed to introduce policies that do not satisfy the constraint in Eqn. (2). Consider any state s∈ [symbol] and any pruned action α′∈ [symbol] (s)\ [symbol] (s) in that state. Consider choosing α′ in s once and thereafter choosing actions as per the optimal policy. The expectation for this is given by

$${Q}_{{M}_{R}}^{{π}^{*}} ( s , {a}^{′} ) = {𝔼}_{{𝒯}_{R}}^{{π}^{*}} [ {r}_{R} ( {s}^{1} ) + {γ}_{R} {V}_{{M}_{R}}^{{π}^{*}} ( {s}^{1} ) \vert {s}^{0} = s , {a}^{0} = {a}^{′} ] .$$

$$From Eqn . ( 4 ) , w . k . t .$$

$${Q}_{{M}_{R}}^{{π}^{*}} ( s , {a}^{′} ) = {δ𝔼}_{{𝒯}_{R}}^{{π}^{*}} [ {r}_{R} ( {s}^{1} ) + {γ}_{R} {V}_{{M}_{R}}^{{π}^{*}} ( {s}^{1} ) \vert {s}^{0} = s , {a}^{0} = {π}^{*} ( s ) ]$$

Since the future states already choose the optimal actions, there is no room to improve the value of

$${Q}_{{ℳ}_{R}}^{{π}^{*}}$$

(s, α′) and hence cannot satisfy δ. Thus, any policy that chooses α′ for s cannot satisfy the constraint in that state.

Lemma 2. Let π and π′ be two deterministic policies that differ by only a single action in some state i.e., ∃sᵢ∈ [symbol] [πⁱ(sᵢ)≠π(sᵢ)]Λ∀sⱼ∈ [symbol] \{sᵢ}[π′(sᵢ)=π(sⱼ)] and satisfy

$${Q}_{{ℳ}_{R}}^{π}$$

(sᵢ, π′(s))≤

$${V}_{{ℳ}_{R}}^{π}$$

(sᵢ). Then, policy π′ is a descendant of π in PDT, i.e., policy π′ is no better than π, or more formally, ∀s∈ [symbol] [

$${V}_{{ℳ}_{R}}^{{π}^{′}}$$

(s)≤

$${V}_{{ℳ}_{R}}^{π}$$

(s)].

Proof. This is an extension of the policy improvement theorem (Sutton and Barto 2018) but in the opposite direction (hence referred to as a policy descent). We know that ∀s∈ [symbol] ,

$${Q}_{{M}_{R}}^{π} ( s , π ( s ) ) = {V}_{{M}_{R}}^{π} ( s )$$

$${𝔼}_{{𝒯}_{R}}^{π} [ {r}_{R} ( {s}^{1} ) + {γ}_{R} {V}_{{M}_{R}}^{π} ( {s}^{1} ) \vert {s}^{0} = s , {a}^{0} = π ( s ) ] = {V}_{{M}_{R}}^{π} ( s )$$

Consider a temporary non-stationary policy π′₁ that chooses the action as per π′ once in the initial state s⁰ and follows π thereafter. ∀s∈ [symbol] ,

$${Q}_{{M}_{R}}^{{π}_{1}^{′}} ( s , {π}_{1}^{′} ( s ) ) \leq {Q}_{{M}_{R}}^{π} ( s , π ( s ) )$$

$${Q}_{{M}_{R}}^{{π}_{1}^{′}} ( s , {π}_{1}^{′} ( s ) ) \leq {V}_{{M}_{R}}^{π} ( s )$$

$${𝔼}_{{𝒯}_{R}}^{{π}_{1}^{′}} [ {r}_{R} ( {s}^{1} ) + {γ}_{R} {V}_{{M}_{R}}^{{π}_{1}^{′}} ( {s}^{1} ) \vert {s}^{0} = s , {a}^{0} = {π}_{1}^{′} ( s ) ] \leq {V}_{{M}_{R}}^{π} ( s )$$

This is because s⁰ can either be sᵢ∈ [symbol] or any sⱼ∈ [symbol] \{sᵢ}.
If s⁰=sᵢ then,

$${Q}_{{ℳ}_{R}}^{π}$$

(Sᵢ, π′(Sᵢ))=

$${V}_{{ℳ}_{R}}^{π}$$

(sᵢ) (given).

If s⁰=sⱼ then,

$${Q}_{{ℳ}_{R}}^{π}$$

(sⱼ, π′(sⱼ))=

$${V}_{{ℳ}_{R}}^{π}$$

(sⱼ) as π′₁ differs from π only in one action in one state sᵢ and follows π in all future states.
Similarly, consider another temporary non-stationary policy π′₂ that chooses the actions as per π′ once in s⁰, again in s¹, and follows thereafter. ∀s∈ [symbol] ,

$${Q}_{{M}_{R}}^{{π}_{2}^{′}} ( s , {π}_{2}^{′} ( s ) ) \leq {Q}_{{M}_{R}}^{{π}_{1}^{′}} ( s , {π}_{1}^{′} ( s ) )$$

$${Q}_{{M}_{R}}^{{π}_{2}^{′}} ( s , {π}_{2}^{′} ( s ) ) \leq {Q}_{{M}_{R}}^{π} ( s , π ( s ) )$$

$${𝔼}_{{𝒯}_{R}}^{{π}_{2}^{′}} [ {r}_{R} ( {s}^{1} ) + {γ}_{R} {V}_{{M}_{R}}^{{π}_{2}^{′}} ( {s}^{1} ) \vert {s}^{0} = s , {a}^{0} = {π}_{2}^{′} ( s ) ] \leq {V}_{{M}_{R}}^{π} ( s )$$

Consider repeating this until we always choose actions as per π′.

$${𝔼}_{{𝒯}_{R}}^{{π}^{′}} [ {r}_{R} ( {s}^{1} ) + {γ}_{R} {r}_{R} ( {s}^{2} ) + {γ}_{R}^{2} {r}_{R} ( {s}^{3} ) + … \vert {s}^{0} = s , {a}^{0} = {π}^{′} ( s ) ] \leq {V}_{{M}_{R}}^{π} ( s )$$

$${V}_{{M}_{R}}^{{π}^{′}} ( s ) \leq {V}_{{M}_{R}}^{π} ( s )$$

Theorem 1. PDT+ returns all Pareto optimal policies in Π*_{ε}.

Proof. To prove this, we show that there exists a policy descent path from any optimal policy (denoted by π*) in [symbol] _{R} (i.e., the root node in PDT) to any Pareto optimal policy (denoted by π*_{ε}) in Π*_{ε} by induction. Let n denote the number of actions a policy differs from π*.

When n=1, i.e. π*_{ε} differs from π* in a single action i.e. ∃sᵢ∈ [symbol] [π*_{ε}(sᵢ)≠π*(sᵢ)]Λ∀sⱼ∈ [symbol] \{sᵢ}[π*_{ε}(sᵢ)=π*(sᵢ)] then, ∀s∈

$$S {Q}_{{M}_{R}}^{{π}^{*}}$$

(s, π*_{ε}(s))≤

$${V}_{{M}_{R}}^{{π}^{*}}$$

(s) as π* is the optimal policy. This makes π*_{ε} one of the direct descendants of π* (by Lem. 2). Hence, π*_{ε} is expanded by PDT.

When n=k, i.e. π*_{ε} differs from π* in any k actions i.e. ∃ [symbol] ₖ⊆ [symbol] [π*_{ε}(sᵢ)≠π*(sᵢ)]Λ∀sⱼ∈ [symbol] \ [symbol] _{K}[π*_{ε}(sⱼ)π*(sⱼ)], assume π*_{ε} is expanded by PDT.

When n=k+1, i.e. π*_{ε} differs from π* in any k+1 actions i.e. ∃ [symbol] ₖ₊₁⊆ [symbol] ∀sᵢ∈ [symbol] ₖ₊₁[π*_{ε}(sᵢ)≠π*(sᵢ)]Λ∀sⱼ∈ [symbol] \ [symbol] ₖ₊₁[π*_{ε}(sⱼ) π*(sⱼ)], there must be at least one action out of the k+1 actions aligning with π* that improves, or is same as, the value of π*_{ε}.

Assume this is false i.e. all the k+1 actions aligning with π* worsen π*_{ε}. The policy introduced by aligning all k+1 actions with π* is π* itself (as all actions other than the k+1 actions in π*_{ε} are same as π*). W.k.t. π* is optimal and cannot be worse than π*_{ε}, which is a contradiction. Thus, an ∃π∃sᵢ∈ [symbol] ₖ₊1[π*_{ε}(sᵢ)≠π*(sᵢ)=π*(sᵢ)]Λ∀sⱼ∈ [symbol] \{sᵢ}[π(sⱼ)=π*_{ε}(sⱼ)] that satisfies

$${Q}_{{ℳ}_{R}}^{{π}_{ε}^{*}}$$

(sᵢ, π(sᵢ))≥

$${V}_{{ℳ}_{R}}^{{π}_{ε}^{*}}$$

(sᵢ) and by Lem. 2, π is no-worse than π*_{ε}. W.k.t. π is expanded (induction assumption). Consequently, π*_{ε} must be one of the direct descendants of π in PDT and hence π*_{ε} is expanded.

Therefore, the result holds for any n by the principle of induction. Finally, the same conclusion holds for PDT+ (by Lem. 1).

Theorem 2. PAG+ returns a policy in the Pareto set π*_{ε}.

Proof. The PAG search process stops when it can no longer improve or find a policy that is equivalent in values to π_{ε} under [symbol] _{R}^{H} while satisfying the safety constraint. This translates to that there does not exist a state-action update that implements a policy ascent step under the constraint i.e., ¬∃(s′∈ [symbol] , α′∈ [symbol] )

$$[ {Q}_{{ℳ}_{R}}^{{π}_{ε}} ( {s}^{′} , {a}^{′} = {π}^{′} ( s ) ) \geq {Q}_{{ℳ}_{R}^{H}}^{{π}_{ε}} ( {s}^{′} , {π}_{ε} ( {s}^{′} ) ) , s . t . ∀ {s}^{′} ∈ 𝒮 [ {V}_{{ℳ}_{R}}^{{π}^{′}} ( {s}^{′} ) \geq δ {V}_{{ℳ}_{R}}^{{π}^{*}} ( {s}^{′} ) ] ] .$$

However, if π_{ε}∉Π*_{ε}, there must exist another policy π∈Π*_{ε} that dominates π_{ε} i.e. ∃(s∈ [symbol] , α∈ [symbol] )

$$[ {Q}_{{ℳ}_{R}^{H}}^{{π}_{ε}} ( s , a = π ( s ) ) > {Q}_{{ℳ}_{R}^{H}}^{{π}_{ε}} ( s , {π}_{ε} ( s ) ) , s . t . ∀ s ∈ 𝒮 [ {V}_{{ℳ}_{R}}^{π} ( s ) \geq δ {V}_{{ℳ}_{R}}^{{π}^{*}} ( s ) ] ] .$$

This contradicts with the fact that no policy ascent step exists.

Therefore, π_{ε}∈Π*_{ε}.

Finally, the same conclusion holds for PAG+ (by Lem. 1).

### 1.6.2 Domain Descriptions

### 1.6.2.1 Simulations

1) Cliff Worlds (CS & CL): In the cliff worlds, the agent is required to navigate alongside the edge of a cliff to reach the goal. We created a small 4×5 grid, referred to as CS (shown in FIGS. 5A-5C) to evaluate exact methods and a large 4×100 grid, referred to as CL (shown in FIGS. 4A-4C) to evaluate approximate methods. To apply approximate methods to CL, the states were aggregated based on features such as distance to the cliff, and agent's position in the grid (e.g., along the edge or at the ends). For CL, we aggregated all non-terminal states into 10 clusters and retained the terminal states (cliffs and goal) as is.

The ground truth ( [symbol] _{R}) is that the agent can traverse alongside the edge without slipping off the cliff. Accordingly, [symbol] is designed such that the agent heads in the right direction with a probability of 0.9 and remains in the same state with a probability of 0.1. The human's belief ( [symbol] _{A}^{H}) is that the agent may slip off from the edge with some probability, and the terrain closer to the cliff is more uneven and hence more difficult for the agent to traverse. Accordingly, ( [symbol] _{R}^{H}) is designed such that the agent heads in the right direction with a probability of 0.7, steers in either direction with a probability of 0.1 each, and remains in the same location with a probability of 0.1.

The reward functions [symbol] _{R} and ( [symbol] _{R}^{H}) are shown in FIGS. 4A and 4B respectively for CL. For CS, the rewards for non-terminal states remain the same but for the cliff states it is −100 instead of −1000, and for the goal state it is 100instead of 1000.

2) Wumpus World (W): In the wumpus world, we created a 5×5 grid referred to as W (shown in FIGS. 3A-3D). To apply approximate methods to W, the non-terminal states were aggregated into 15 clusters based on features such as the relative direction of the wumpus from agent and collection status of the gold coins. The agent is required to exit the 5×5 cave while collecting gold coins on its way out and avoiding encounters with the wumpus (i.e., staying in the same location). The cave has a moving wumpus, two gold coins, and an exit location.

The ground truth ( [symbol] _{R}) is that the agent's movement is deterministic and the wumpus's movement is stochastic. Accordingly, [symbol] is designed such that the wumpus always chooses to move toward the agent's current location with uniform probability. The human's belief ( [symbol] _{R}^{H}) is that the actions of both agents are stochastic. Under such a belief, the human would consider it dangerous for the agent to move close to the wumpus. Accordingly, [symbol] _{R}^{H} is designed such that the dynamics of the agent's movement are the same as that in the cliff world and the dynamics of the wumpus's movement is to move close to the agent's current location with uniform probability.

In reward functions [symbol] _{R} and [symbol] _{R}^{H}, collecting each gold coin gives a reward of +30. The game terminates if the agent encounters the wumpus with a reward of −100 or if it exits the cave with a reward of +100. The living reward is −0.1.

### 1.6.2.2 Physical Robot Experiment

Robot Assistant Domain: In this domain, a Kinova MOVO robot is assisting a human user with setting up the dining table (refer to FIGS. 6A and 6B). The state was modeled to include the location of an object (which was a napkin in this experiment), the location of an obstacle (which was a vase in this experiment), and the location of the robot. The possible locations for the napkin are viz., on the side table (shown in the top sub-figures), on the front table next to the vase which is away from the human, on the front table next to the plate which is near the human (shown in the bottom sub-figures), and in the robot's gripper (shown in the middle sub-figures). The possible locations for the vase are near the robot (shown in left sub-figures) and away from the robot (shown in right sub-figures), and fallen (if tipped over which is not shown). The possible locations for the robot are close to the side table (shown in the right sub-figures) and close to the human (shown in the middle-left and middle-right sub-figures). The robot is required to fetch a napkin for the user from another table. In the robot's model ( [symbol] _{R}), movement of the arms is restricted by a vase on the table such that placing the napkin close to the user may tip over the vase containing water, resulting in a safety risk. Hence, the robot's optimal behavior is to pick the napkin from the side table and place it next to the vase, which is further away from the user. Accordingly, [symbol] _{R} is designed such that moving the napkin from the side table directly toward the human with the obstacle in the way (w.r.t. the robot position) will result in tipping the vase with probability 1.0. However, clearing the vase could successfully displace it with a probability of 0.9, tip it over with a probability of 0.05 and leave it as is with a probability of 0.05.

The user does not fully understand the kinematic constraints of the robot arms and hence expects the robot to place the napkin next to the plate which is close to her.

Accordingly, [symbol] _{R}^{H} is designed such that the robot can access any location on the table irrespective of its own location or the location of the obstacle. In both [symbol] _{R} and [symbol] _{R}^{H}, the probability of executing an action successfully is 0.9 and the probability of failing is 0.1.

The environment terminates when the napkin is placed in any location on the table or if the flower vase is tipped over. In [symbol] _{R}, there is an equal reward of 10 for placing the napkin anywhere on the table and −10 for hitting the vase. In [symbol] _{R}^{H}, there is a reward of 10 for placing the napkin close to the human and 0 reward for placing the napkin anywhere else on the table.

### 1.6.3 Discussion and Conclusions

In this section of the disclosure, we introduced the problem of Safe Explicable Planning (SEP), which significantly extends explicable planning to support a safety bound. To focus on the planning challenges of introducing safety in explicable planning, we assume the human belief model [symbol] _{R}^{H} is known. We provide references to existing literature where a similar assumption is made. When [symbol] _{R}^{H} is unknown, it can be learned by querying human subjects, to learn a reward function such as the approaches discussed in (Wirth et al. 2017) and to learn domain dynamics such as the approach by (Zhuo 2015). We defer the consideration of other forms of [symbol] _{R}^{H} (such as hierarchical models) or learning [symbol] _{R}^{H} for future work. It is worth noting that the problem of SEP can be formulated as a CMDP problem under the special case where [symbol] = [symbol] _{R}^{H} and γ_{R}=γ_{R}^{H}, in planning (Altman 2021) or learning (Achiam et al. 2017) setting.

In our work, we assume that safety is correlated to the expected return in the agent's model under the intuition that unsafe behaviors would result in low returns. Thus, imposing a lower bound on the return prevents unsafe behaviors. Such a safety definition is based on the constrained criterion. We aim to extend it to consider other safety formulations such as the worst-case criterion etc. outlined in (Garcia and Fernandez 2015) in the future. It would also be interesting to study how our value function-based criterion can be compared with or potentially equated to a state-machine-based criterion such as that studied by (Hunt et al. 2021). For example, prior work has studied how LTL constraints can be approximately considered by shaping the reward function (Camacho et al. 2019; Li, Vasile, and Belta 2017). Further, the safety bound in our work is domain-specific as the criticality of safety is different in different scenarios and can be specified by the designer. We discuss how the safety bound was determined for the experimental evaluations and will more systematically address it in future work.

Our problem formulation generalizes the consideration of objectives from multiple models and the solution is a Pareto set of policies. We proposed an action pruning technique to reduce the search space, an exact method that returns the Pareto set, and a greedy method that returns a single policy. Existing literature in MOMDP shows that finding exact Pareto solutions for complex problems is intractable. To scale to complex domains, we further discussed approximate solutions by clustering states that are alike in terms of action selection. Since SEP requires searching the policy space, the methods proposed (exact and approximate) are still susceptible to policy explosion in large domains. The aggregation-based approximation proposed is preliminary work toward finding approximate safe explicable policies. We defer the study of generalized and more efficient approximation techniques to solve SEP in the future.

### 2. Safe Explicable Policy Search for Trajectory Generation in Continuous Stochastic Environments

### 2.1. Introduction

Recent developments in Artificial Intelligence (AI) have led to AI systems being widely deployed for user access. Users are increasingly involved in close interaction with these systems, forming a team-like relationship. In such cases, users form expectations of these “teammates”. For successful teaming interactions, it is important that user expectations are met. Otherwise, it may lead to user confusion, poor teaming performance, and loss of trust.

Generally, users may not always be experts in AI systems, which may lead to them forming expectations that are different from the system's planned behaviors. These differences may be due to, for instance, different understandings of the task objective and/or domain dynamics during decision-making. Explicable planning addresses the planning challenges where the Al agent aims to generate more expected plans or policies under such model differences. However, when the agent focuses on meeting user expectations, it may lead to safety issues.

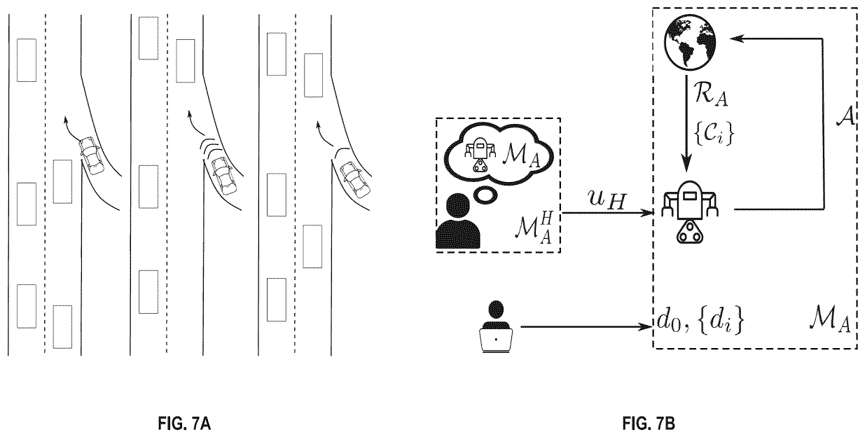

Section 1 of the present disclosure introduced the problem of Safe Explicable Planning (SEP) that aims to find user expected policies that are safe by considering a safety bound (provided by an expert) in the agent's decision making (FIG. 7B), employing PDT and PAG. However, Section 1 is limited to discrete states and actions, and to a planning setting where the models of the agent and the user (for generating expectations of the agent) are known. In reality, it is desirable for such methods to work in environments with continuous states and actions, and, more importantly, when the user's model is not directly available. This portion (Section 2) of the present disclosure bridges the gap by outlining a method for finding safe and explicable policies in continuous stochastic environments in a reinforcement learning (RL) setting. It is worth noting that, in a planning setting, the solution is a final plan or policy that is safe. However, in a learning setting, the solution may require the agent to be safe even during the learning process.

Consider a motivating example, shown in FIG. 7A, where an autonomous driving car is to merge with highway traffic. The safety criterion is to maintain a minimum distance from both the car immediately in front and the car immediately behind. The AI driving agent aims at saving energy (by reducing acceleration and deceleration) while the human values travel time more. The expected behavior is to merge as fast as it can. Even when assuming safety is assured, it may result in sudden and harsh acceleration and/or deceleration when the front and/or rear cars are very close to the AI agent. The optimal behavior to the agent is to slow down to wait for a better opportunity (where more distance in between the AI agent and the other cars are observed) to smoothly accelerate and merge. The safe explicable behavior may involve alternating between deceleration and acceleration for an opportunity (with moderate distances between the AI agent and other cars) to merge that does not require too much waiting. The proposed Safe Explicable Policy Search (SEPS) aims to best match the user's expectation within the agent's safety and quality limits, thus avoiding unsafe and inefficient behaviors during and after learning.

Both safe behavior and explicable behavior generation, considered independently, can be addressed by the existing methods. For example, Constrained Markov Decision Process (CMDP) and its solution techniques, are effective in optimizing a task objective subject to safety constraints. The challenge in our problem is that the objective is defined over two different models with potentially different objectives and domain dynamics. This limits us from directly applying CMDP solutions. Similarly, a previous study on Explicable Policy Search (EPS) proposes learning a surrogate reward function from user feedback on the agent's behavior to inform learning. It is more practical than learning both the objective and domain dynamics and hence can be applied when the user's model is unknown. However, EPS depends on the specification of a reconciliation parameter, and a weighting parameter for a few entropy terms, to combine an explicability score with the agent's objective. It requires careful fine-tuning via trial and error due to the difficulty in relating these hyper-parameters to the importance of the objectives reconciled since they are at different scales (i.e., reward vs. entropy). We propose SEPS to combine the capabilities of CMDP (CPO) and EPS while avoiding these limitations in addressing safe explicable behavior generation.

Towards this end, we first formulate our objective based on EPS since it allows us to convert the consideration of two models to the consideration of two linearly combined objectives. This is particularly beneficial since it enables us to focus policy search on a single model, thus allowing us to apply CPO to the new objective. Meanwhile, to relax the requirement of the hyper-parameters, we adapt and reformulate the objective by breaking it into an objective and a constraint, where the constraint can be absolved into the CPO formulation, leading to a novel integration of CPO and EPS while avoiding their limitations for safe explicable behavior generation. The remaining challenge lies in the derivation of an analytic solution for the resulting constrained optimization problem, for which we provide a solution for the most common case with two constraints. Furthermore, we evaluate SEPS in different safety-gym environments and with a physical robot experiment. The results show that our approach is effective in searching for an explicable policy within the safety limits. Our approach also demonstrates its applicability to real-life scenarios in the robot experiment.

### 2.2. Related Work

With recent developments in AI, AI agents become accessible to various users where they either work alongside or interact with them. This has motivated advancements in Explainable AI (XAI) with the aim of building AI agents whose behavior is explainable to users. Our work is related to research that focuses on generating user-understandable behavior which is studied under different terminologies, viz., legibility, predictability, transparency, explicability, etc.

In the spectrum of Explainable AI literature, our work is most related to explicable planning, a framework for finding a user expected behavior while balancing the costs incurred to the agent. These studies propose different methods to measure similarity to user expectations but do not consider safety issues. Other studies that consider human feedback in the agent's learning process are capable of learning user preferred behavior in the presence of an expert designed RL objective. However, these methods assume the user's belief of the domain dynamics is the same as that of the agent, which can lead to learning undesired behaviors. Furthermore, these approaches do not consider safety issues either.

Safe Explicable Planning (SEP) as described in Section 1 of the present disclosure extends explicable planning to support the specification of a safety bound. However, the discussion in Section 1 is limited to a planning setting where the decision models are given. In reality, such models may be difficult to provide a priori. Furthermore, it requires searching through the policy space, which is intractable in large, continuous MDPs. In this work, we consider the problem of finding a safe explicable policy in a reinforcement learning setting. However, we assume that the information regarding the user's model is learned from user feedback and is given. This allows us to focus on developing the methodology for SEPS. Furthermore, unlike SEP, in our formulation, we consider the general case of continuous state and action spaces.

In Section 2 of the present disclosure, we define the agent's decision model as a Constrained Markov Decision Process (CMDP), which allows us to specify the costs associated with safety separately from the agent's task objective. CMDPs are popularly used in Safe RL due to the ease of safety specification. Several techniques have been proposed to solve safe RL formulated as CMDPs. However, these methods cannot be directly applied to solve SEPS due to its problem setting (refer to FIG. 7B), where the optimization is under two different models, specifically different domain dynamics models (or transition models in MDPs).

### 2.3. Preliminaries

A Markov Decision Process (MDP) is represented by a tuple [symbol] = [symbol] , [symbol] , [symbol] , [symbol] , ρ, γ [symbol] , where [symbol] is the set of states, [symbol] is the set of actions, [symbol] : [symbol] × [symbol] × [symbol] [symbol] [0, 1] is the transition probability function, [symbol] : [symbol] × [symbol] × [symbol] [symbol] [symbol] is the reward function, ρ(s) is the initial state distribution, and γ is the discount factor. A stationary policy π: [symbol] [symbol] [symbol] ( [symbol] ) is a map from states to probability distribution over actions, with π(α|s) denoting the probability of selecting action α in state s. We denote the set of all stationary policies by Π. The performance (expected discounted return) of a policy w.r.t. a measure [symbol] under the transition dynamics [symbol] is typically given by [symbol] (π)≐ [symbol] [Σₜ₌₀^{∞}γ^{t} [symbol] (sₜ, αₜ, sₜ)], where τ˜ [symbol] π, [symbol] [symbol] indicates that the distribution over trajectories depends on π and [symbol] i.e., s₀˜ρ, αₜ˜π(·|sₜ), sₜ₊₁˜ [symbol] (·|sₜ, αₜ). The probability of realizing a trajectory τ with policy π is p(τ)=ρ(s₀)Πₜ(sₜ₊₁|sₜ, αₜ)π(αₜ|sₜ). Reinforcement learning algorithms seek to learn a policy that maximize the performance, i.e., π*=argmax_{π∈Π} [symbol] (π).

A constrained Markov Decision Process (CMDP) is an MDP augmented with constraints that restrict the permissible policies for the MDP. Specifically, [symbol] is augmented by auxiliary cost functions { [symbol] ᵢ}_{i=1:k} and limits {dᵢ}_{i=1:k} where each [symbol] ᵢ: [symbol] × [symbol] × [symbol] [symbol] [symbol] is a function, same as [symbol] . The performance of a policy w.r.t. [symbol] ᵢ is [symbol] (π)= [symbol] [Σₜ₌₀^{∞}γ^{t} [symbol] ᵢ(sₜ, αₜ, sₜ₊₁)], Then, the set of all feasible stationary policies is denoted by [symbol] ≠{π∈Π: ∀i [symbol] (π)≤dᵢ}. The objective of a CMDP is to learn a feasible policy that maximizes the performance π*=argma [symbol] [symbol] (π).

In explicable policy search (EPS), two MDP models, the agent's model M_{A} and the user's belief of the agent's model M_{A}^{H}, are considered at play. The two MDPs share the same [symbol] , [symbol] , ρ, and γ but may differ in their domain dynamics ( [symbol] , [symbol] _{A}^{H}) and their reward functions ( [symbol] _{A}, [symbol] _{A}^{H}). In EPS, the aim is to search for a policy that maximizes two objectives: the expected cumulative reward, and a policy explicability score, linearly weighted by a reconciliation factor (λ) i.e.,

$${π}^{*} = arg {max}_{πϵΠ} {J}_{{ℛ}_{A} , {𝒥}_{A}} ( π ) + λε ( π , {M}_{A} , {π}_{A}^{H} , {M}_{A}^{H} ) . \qquad ( 7 )$$

The explicability score ε(·)=− [symbol] _{KL}(p_{A}(τ)∥p_{A}^{H}(τ)) is well motivated and is defined as the negative KL-divergence of the trajectory distributions in the agent's model and the human's model denoted by p_{A}(τ) and p_{A}^{H}(τ) , respectively. Essentially, the agent that maximizes ε(·) would learn to replicate (as closely as possible) the human's expected behavior of the agent.

Estimating the parameters in p_{A}^{H}(τ) (i.e. [symbol] _{A}^{H} and π_{A}^{H}), individually, is expensive. Instead, t a surrogate reward function u_{H} can be “learned” via a preference-based learning framework by presenting pairs of trajectories and asking human subjects which trajectory is expected. The learned reward function u_{H} correlates with the distribution of human expected trajectories, p_{A}^{H}(τ). Furthermore, assuming a parametrized agent policy π_{θ}, the surrogate reward signal and other log terms in the explicability measure effectively reshape the reward function in Eq. 7 and is approximated by the objective

$${θ}^{*} ≐ arg {max}_{πθ} {𝔼}_{pA} [ {\sum }_{t} {γ}^{t} ( {ℛ}_{A} ( {s}_{t} , {a}_{t} ) + λ ( {u}_{H} ( {s}_{t} , {a}_{t} ) + {ℋ}_{{𝒥}_{A}} ( {s}_{t + 1} ) \vert {s}_{t} , {a}_{t} ) + {ℋ}_{{π}_{θ}} ( {a}_{t} \vert {s}_{t} ) ) ] , \qquad ( 8 )$$

where u_{H}(sₜ, αₜ)= [symbol] _{A}^{H}(sₜ₊₁|sₜ, αₜ)+π_{A}^{H}(αₜ|sₜ)+C₁, and where [symbol] _{π}_{_{θ}}is the policy entropy term (similar to MaxEntRL) which incentivizes the agent to explore uncertain actions, and [symbol] is the environment entropy term which incentivizes the agent to explore parts of the environment that has more stochasticity.

### 2.4. Problem Formulation

In this section, we motivate and discuss the formulation of SEPS by incorporating the benefits of CMDP solution techniques (specifically, that of CPO) with EPS. Extending CPO to generate safe explicable policies is not straightforward due to the consideration of the objective over two different MDP models. We refer the reader to SEP, which discusses the challenges of solving a constrained optimization problem defined over two separate transition models. Similarly, extending EPS to generate safe explicable policies requires the specification of a reconciliation parameter, and a weighting parameter for a couple of entropy terms to scale the different measures with the reward appropriately. We propose a formulation for SEPS that systematically combines the capabilities of CPO and EPS while eliminating their limitations towards finding safe explicable policies.

Exhibiting explicable behavior is important for successful teaming. A popular objective for finding explicable plan or policy is to optimize an objective that linearly combines the agent's rewards with an explicability measure. However, being explicable at the cost of safety can be dangerous. Hence, it is unacceptable to compromise safety.

Ensuring safety in a task means avoiding or reducing harm. Implicitly, any task assumes successful completion without causing harm. For instance, if an agent is tasked with fetching hot coffee, an underlying safety assumption is that it does not bump into anyone on its way or spill the hot coffee. One approach, albeit nonideal, is to optimize an objective that balances risk penalties along with rewards, and explicability. This requires carefully scaling each component to provide a meaningful learning signal at every step, preventing issues like reward hacking. In safety-critical tasks, designing a single reward that simultaneously drives task completion and discourages unsafe behavior is challenging. A common approach is to define the reward as [symbol] =R−ωC, where R represents the task reward component, and C denotes the safety cost. However, results from CPO demonstrate high sensitivity to the penalty coefficient ω, highlighting the difficulty of crafting an effective overloaded reward function. Prior research also emphasizes the importance of separating the task objective from safety constraints, as done in CMDPs, to enable the agent to learn meaningful behavior.

CMDP methods efficiently optimize the task objective while enforcing safety constraints. Ideally, an agent should act both explicably (which involves considering two models) and efficiently while satisfying safety requirements. However, a CMDP requires both the objective and constraints to be defined under a single transition model. To address this, we propose to consider the objective in EPS, since it converts the consideration of two models to the consideration of two linearly combined objectives under a single transition model, as shown below,

$$\begin{matrix}{π}^{*} = arg {max}_{{πϵΠ}_{d}} {J}_{{ℛ}_{A} , {𝒥}_{A}} ( π ) + λℰ ( π , {ℳ}_{A} , {π}_{A}^{H} , {ℳ}_{A}^{H} ) . \\ s . t . {J}_{{𝒞}_{i} , {𝒥}_{A}} ( π ) \leq {d}_{i} i = 1 , … , k .\end{matrix} \qquad ( 9 )$$

This objective has two main limitations: 1) similar to the penalty coefficient, determining an appropriate reconciliation factor (λ) can be challenging; and 2) since the task objective is maximized alongside explicability, for λ>0, there is no guarantee of task performance in the agent's model, especially when λ is high. To overcome these issues, we propose to constrain the agent's task objective instead of linearly combining it with the explicability measure as below.

$$\begin{matrix}{π}^{*} = arg {max}_{{πϵΠ}_{d}} ℰ ( π , {ℳ}_{A} , {π}_{A}^{H} , {ℳ}_{A}^{H} ) . \\ s . t . {J}_{{ℛ}_{A} , {𝒥}_{A}} ( π ) \geq {d}_{0} \\ {J}_{{𝒞}_{i} , {𝒥}_{A}} ( π ) \leq {d}_{i} i = 1 , … , k .\end{matrix} \qquad ( 10 )$$

where ε(·) can be written as [symbol] (π) based on Eq. 8. Essentially, [symbol] (π)≐ [symbol] [Σₜ₌₀²⁸γ^{t}(u_{H}(sₜ, αₜ)+ [symbol] (sₜ₊₁|sₜ, αₜ)+ [symbol] _{π}_{_{θ(α}}ₜ|sₜ))]. Since the entropy terms ( [symbol] and [symbol] _{π}_{_{θ}}) are approximated separately from the surrogate reward (u_{H}), they require additional scaling parameters which are not straightforward to determine. In our work, we mitigate this by simply maximizing u_{H}. This means that instead of maximizing the negative KL divergence between the trajectory distributions, we maximize the probability of the most expected trajectory that the agent can generate.

First, let us define the components involved in formulating SEPS. The agent's decision model is modeled as a CMDP augmented with an additional limit on the task objective i.e., [symbol] _{A}= [symbol] [symbol] , [symbol] , [symbol] , [symbol] _{A}, { [symbol] ᵢ}_{i=1:k}, {dᵢ}_{i=0:k}, ρ, γ [symbol] where, d₀ is the limit on the task objective [symbol] _{A} and d₁, . . . , dₖ are limits on the cost functions [symbol] ₁, . . . , [symbol] ₖ, respectively. The user's belief of the agent's model is modeled as an MDP i.e., [symbol] _{A}^{H}= [symbol] [symbol] , [symbol] , [symbol] _{A}^{H}, [symbol] _{A}^{H}, ρ, γ [symbol] . Given the two decision models, we define SEPS as below.

Definition 1: Safe Explicable Policy Search (SEPS) is the problem of searching for a policy that maximizes the probability of the user's expected trajectory subject to the constraints on the task objective and the costs associated with safety in the agent's model, or formally,

$${π}^{*} \dot{=} arg {max}_{π ∈ {Π}_{d}} {J}_{{u}_{H} , {𝒯}_{A}} , ( π ) \qquad ( 11 )$$

$$s . t . {J}_{{ℛ}_{A} , {𝒯}_{A}} ( π ) \geq {d}_{0}$$

$${J}_{{𝒞}_{i} , {𝒯}_{A}} ( π ) \leq {d}_{i} i = 1 , … , k .$$

It is interesting to note that in the special case where [symbol] and [symbol] _{A}^{H} are identical, u_{H} closely approximates the user's reward model [symbol] _{A}^{H}. However, we note that the goal of learning u_{H} is to obtain feedback on the user's assessment of explicableness (based on his own model— [symbol] _{A}, [symbol] _{A}^{H}) of agent's behavior, i.e., when the agent operates under the true domain dynamics [symbol] . Therefore, the SEPS problem in Eq. 11 is equivalent to the Safe Explicable Planning problem formulation outlined in Section 1.

$${π}^{*} \dot{=} arg {max}_{π ∈ {Π}_{d}} {J}_{{ℛ}_{A}^{H} , {𝒯}_{A}^{H}} , ( π ) \qquad ( 12 )$$

$$s . t . {J}_{{ℛ}_{A} , {𝒯}_{A}} ( π ) \geq {d}_{0}$$

$${J}_{{𝒞}_{i} , {𝒯}_{A}} ( π ) \leq {d}_{i} i = 1 , … , k .$$

### 2.5. Safe Explicable Policy Search

Initial work on Safe Explicable Planning (SEP) as outlined in Section 1 of the present disclosure shows searching through the policy space while evaluating policies in the agent's model for feasibility and in the user's model for explicablity. The SEP algorithms iterate over all states and actions to find an optimal, safe explicable policy, which can be impractical for continuous MDPs. The SEPS problem in Eq. 11 reduces to a CMDP, allowing us to use its policy search techniques. CPO is a popular approach to solving CMDP as it ensures safe behavior even during the learning process. However, the algorithm is limited to solving an objective with a single constraint. Therefore, we require an analytic solution to efficiently solve SEPS. As the number of constraints increases, deriving feasible bounds for the solution becomes challenging due to the intersection of feasible regions of every constraint.

Let us introduce some useful notations. The on-policy value function and action-value function in the agent's model, over a general reward function [symbol] , are given by [symbol] (s)≐ [symbol] [Σₜγ^{t} [symbol] (sₜ, 60 ₜ)|s₀=s] and [symbol] (s, α)≐ [symbol] [Σₜγ^{t} [symbol] (sₜ, αₜ)|s₀=s, α₀=α], respectively. Then, the corresponding advantage function is [symbol] (s, α)≐ [symbol] (s, α)− [symbol] (s). The function [symbol] may be replaced by u_{H}, [symbol] _{A}, or any [symbol] ᵢ.

CPO applies trust region policy optimization (TRPO) to policy search updates in a CMDP. Using the notation above, the formulation in Eq. 11 can be written as a policy update rule given by

$${π}^{n + 1} = arg {max}_{π ∈ {Π}_{θ}} {𝔼}_{{π}^{n} , {𝒯}_{A}} [ {A}_{{u}_{H}}^{{π}^{n}} ( s , a ) ] \qquad ( 13 )$$

$$s . t . {J}_{{ℛ}_{A} , {𝒯}_{A}} ( {π}_{n} ) + \frac{1}{1 - λ} {𝔼}_{{π}^{n} , {𝒯}_{A}} [ {A}_{{ℛ}_{A}}^{{π}^{n}} ( s , a ) ] \geq {d}_{0}$$

$${J}_{{𝒞}_{i} , {𝒯}_{A}} ( {π}_{n} ) + \frac{1}{1 - λ} {𝔼}_{{π}^{n} , {𝒯}_{A}} [ {A}_{{𝒞}_{i}}^{{π}^{n}} ( s , a ) ] \geq {d}_{i} i = 1 , … , k$$

$${\overline{𝒟}}_{K L} ( π \vert {π}_{n} ) \leq δ$$

where, Π_{θ}⊂Π is a set of parameterized policies with parameters θ, [symbol] _{KL}(π∥πₙ)= [symbol] _{s˜π}_{ⁿ}[ [symbol] _{KL}(π∥πₙ)[s]] is a measure of KL Divergence between the current policy πₙ and a potential new policy π, and δ>0 is the step size. The set of policies that satisfy the third constraint is called the trust region, i.e. {π_{θ}∈Π_{θ}|D̅_{KL}(π∥πₙ)≤δ}.

For continuous MDPs with high dimensional spaces, solving Eq. 13 exactly is intractable and requires an approximation. The CPO method proposes the following approximation

$${θ}_{n + 1} = arg {max}_{θ} {g}^{T} ( θ - {θ}_{n} ) \qquad ( 14 )$$

$$s . t . {c}_{0} - {b}_{0}^{T} ( θ - {θ}_{n} ) \leq 0$$

$${c}_{i} + {b}_{i}^{T} ( θ - {θ}_{n} ) \leq 0 i = 1 , … , k$$

$$\frac{1}{2} {( θ - {θ}_{n} )}^{T} H ( θ - {θ}_{n} ) \leq δ$$

where, g is the gradient of the objective (explicability measure), b₀ is the gradient of the constraint on agent's task objective, bᵢ is the gradient of the constraint i, c₀≐− [symbol] (πₙ)+d₀, cᵢ≐ [symbol] (πₙ)=dᵢ, and H is the Hessian of the KL Divergence. The optimization problem mentioned above is convex. For policies with high-dimensional parameter spaces like neural networks, the primal problem above is impractical to solve (even with few constraints) using any convex program solver due to the computation complexity of the Hessian matrix.

Feasible case: When the problem is feasible the dual to the above is easier to solve and is given by

$${max}_{λ \geq 0 , v ⪰ 0} \frac{- 1}{2 λ} ( {g}^{T} {H}^{- 1} g + 2 {r}^{T} v + {v}^{T} S v ) + {v}^{T} c - λ δ \qquad ( 15 )$$

where c≐[c₀, c₁, . . . , cₖ]^{T}, B≐[b₀, b₁, . . . , bₖ], r≐g^{T}H⁻¹B, and S≐B^{T}H⁻¹B. Here, the product terms involving the inverse of the Hessian matrix can be approximately computed using a reinforcement learning-based policy optimization such as, for example, Trust Region Policy Optimization (Schulman et al.). If λ* (Lagrangian of a trust region constraint of a first dual optimization function, i.e., Eq. 15) and v* (Lagrangian of a linear constraint of the first dual optimization function) are optimal solutions to the dual above. The update rule for the feasible case is

$${θ}_{n + 1} = {θ}_{n} - \frac{1}{λ} {H}^{- 1} ( g + v B ) \qquad ( 16 )$$

Infeasible case: When the policy π_{θ}_{ₙ} is infeasible, due to a bad step taken previously (occurs due to approximation), the system can recover by updating the policy parameters to strictly reduce the constraint violation. In this case, the update rule is found by solving the following optimization problem depending upon the constraint being violated

$${θ}_{n + 1} = arg {min}_{θ} {c}_{m} - {b}_{m}^{T} ( θ - {θ}_{n} ) where , m ∈ [ 0 , k ] \qquad ( 17 )$$

$$s . t . \frac{1}{2} {( θ - {θ}_{n} )}^{T} H ( θ - {θ}_{n} ) \leq δ$$

The dual to the above is

$${max}_{ϕ \geq 0} - \frac{s}{2 ϕ} + {c}_{m} - ϕδ . \qquad ( 18 )$$

where s=bₘ^{T}H⁻¹bₘ. If ϕ* (Lagrangian for the constraint

$$\frac{1}{2} {( θ - {θ}_{n} )}^{T} H ( θ - {θ}_{n} ) \leq δ$$

of the optimization function Eq. 17, the dual of which is a second dual optimization function Eq. 18) is the solution to the dual above. The update rule for the infeasible case is

$${θ}_{n + 1} = {θ}_{n} - \frac{1}{ϕ} {H}^{- I} {b}_{m} \qquad ( 19 )$$

When multiple constraints are violated, we solve Eq. 17 for each violating constraint and combine the solutions in Eq. 19. This adjusts the policy towards the feasible region w.r.t. all constraints in a single step. Alternatively, one could update the policy with respect to only one constraint at a time.

We derive an analytical solution to SEPS for both feasible and infeasible cases above (refer to Theorems 1 and 2 in section 2.8 of the present disclosure) when a single cost function is present, resulting in two constraints.

### 2.6. Evaluation

We evaluated our method in continuous safety-gym environments and with a physical robot experiment. We designed the evaluation scenarios, including the risk elements. In all of the evaluations, we assume a learned surrogate reward function that captures SEPS relevant information regarding the user model. The goal of our evaluation is: 1) to validate the efficacy of our method to search for safe explicable policies which meet user expectations and are safe and efficient; 2) to analyze the behaviors generated by our method in comparison with that in the agent's model and user expectations; and 3) to demonstrate the applicability of SEPS to real-world scenarios.

### 2.6.1. Safety

In our first evaluation, we aim to answer ‘What are the benefits of safety constraints in explicable planning?’ and ‘Is SEPS's policy explicable under safety constraints?’. We design an evaluation scenario such that the user's expectations conflict with the safety requirements of the agent.

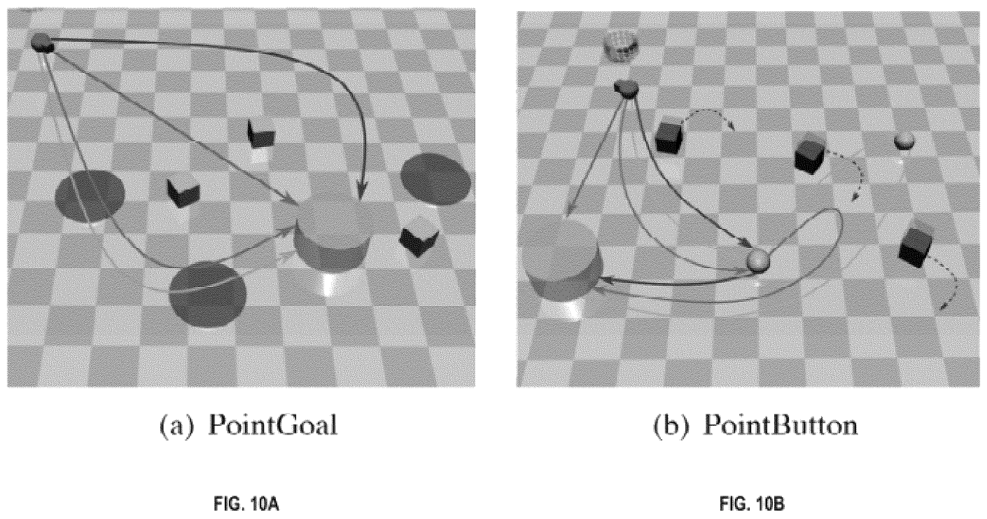

We conduct this evaluation on the safety-gym's PointGoal task as shown in FIG. 10A. Here, the agent is required to reach the goal (green) while avoiding stepping into hazardous areas (dark blue) and hitting vases (light blue). In the agent's model, the task objective is to reach the goal efficiently. Furthermore, there are constraints on the costs associated with hazards and vases. We assume the user's belief of the agent's objective includes avoiding moving close to vases as they are considered fragile. However, the user is unaware of the safety risk associated with the agent entering the hazardous areas.

We evaluated SEPS against the agent's performance in its own model ( [symbol] _{A}), under user expectations (u_{H}), and under EPS (EPS). Here, no safety constraints are incorporated into the baselines u_{H} and EPS, to emphasize the need for safety constraints in explicable planning. In the next evaluation, we will incorporate the consideration of safety constraint into these baselines to compare with SEPS. We compared the behaviors generated and the returns obtained under the surrogate reward, the agent's task reward, and the cost function.

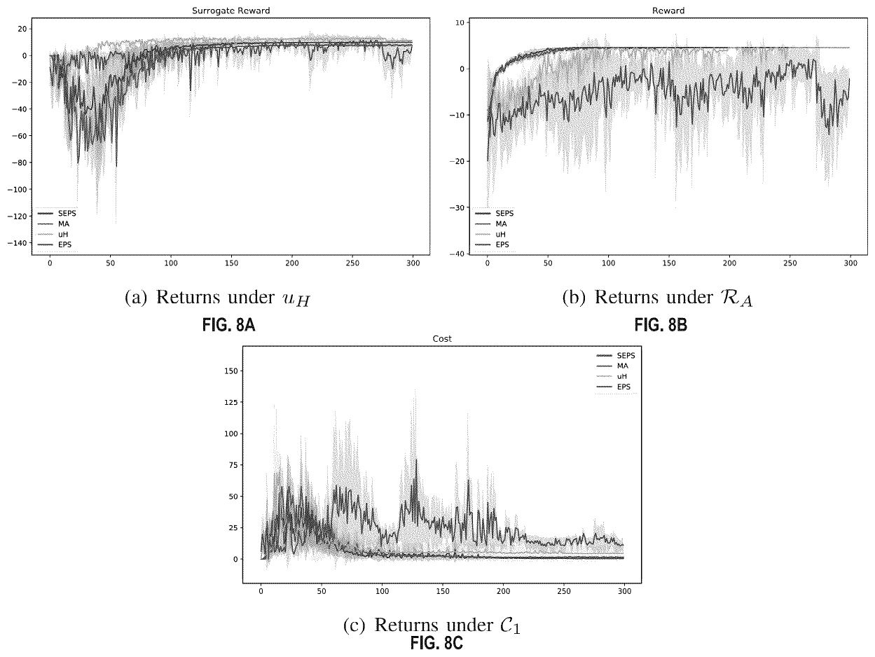

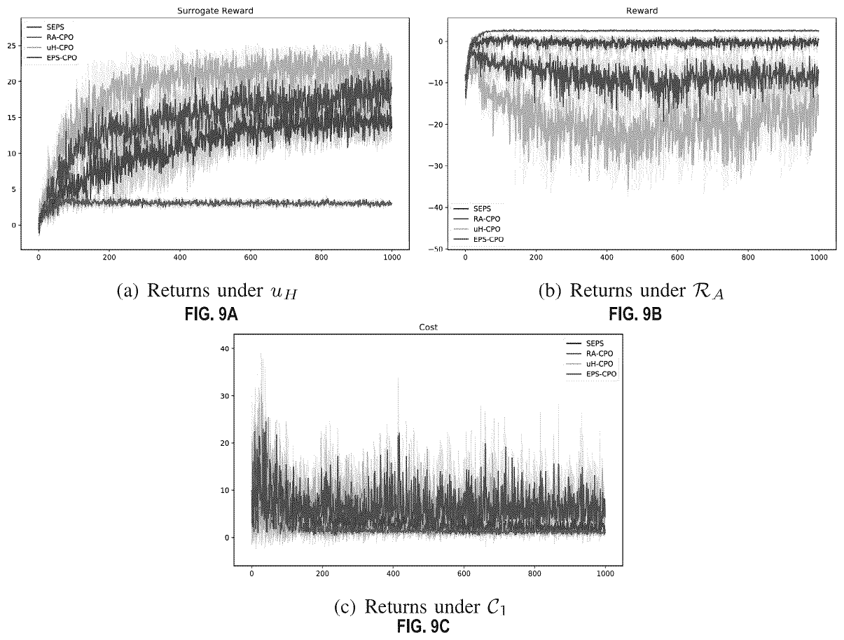

The results of this evaluation are shown in FIGS. 8A-8C. The main result is in the violation of safety constraints reflected in the returns under the cost function [symbol] ₁ shown in FIG. 8C. The closer the cost return to 0, the safer the behavior is. u_{H} and EPS resulted in more safety violations than SEPS and the optimal behavior (which happened to incur a low cost due to the environment setting). This is due to the fact that the surrogate objective only includes consideration of the vases. EPS incurred the most cost since it sometimes resulted in the agent wandering around without reaching the goal, leading to the low return in FIG. 9B and demonstrating the instability issue due to linearly combining objectives. Even though the agent in SEPS executed a curvy path to the goal, its return in [symbol] _{A} is almost as high as the optimal behavior (FIG. 9B). This is because the task objective in the agent's model features a penalty proportional to its displacement from the goal. As long as the agent makes progress towards the goal (whether straightly or in a curve), little penalty would be given.

FIG. 10A shows the behaviors generated in the PointGoal task. As user model is assumed to not associate risk with hazardous regions but only with vases, u_{H} and EPS generated unsafe trajectories that passed through hazardous regions. In [symbol] _{A}, the agent followed the most efficient path to reach the goal without colliding with the vases or entering the hazardous regions, although such a path narrowly passing through the two vases may be seen as risky. SEPS also avoided hazardous regions and staying further away from the vases, to be explicable.

### 2.6.2. Efficiency

In our second evaluation, our aim is to answer ‘Is the agent efficient under its own task objective?’ and ‘Is SEPS's policy explicable and safe while being efficient?’. We designed an evaluation scenario where the user's model aligned with the safety requirements of the agent but differed from the agent's task objective.

We conducted this evaluation in a modified version of the safety-gym's PointButton task as shown in FIG. 10B. Here, the agent is required to reach the goal (green) while avoiding contact with moving gremlins (purple). In addition, there are two buttons (orange) in the environment that can be pressed for a small reward. In the agent's model, the task objective is to reach the goal efficiently subject to constraints on the costs associated with gremlins. We assumed that the user's belief of the agent's objective was to press all the buttons to maximize its reward before reaching the goal while avoiding the gremlins.

We evaluated SEPS against three baselines that enforce safety constraints via CPO: the agent's objective [symbol] _{A}-CPO, the user's expectations (surrogate reward) u_{H}-CPO, and Explicable Policy Search EPS-CPO. We compared the behaviors generated and the returns obtained under the surrogate reward, the agent's task reward, and the cost function.

The results for this evaluation are shown in FIGS. 9A-9C. As u_{H}-CPO solely optimizes the surrogate objective (u_{H}), it performed poorly under the agent's task objective ( [symbol] _{A}). Similarly, as [symbol] _{A}-CPO solely optimizes [symbol] _{A}, it performed poorly under u_{H}. Explicable Policy Search (EPS), when optimized subject to safety constraints (EPS-CPO), achieved better performance under the surrogate reward but performed poorly under the agent's task objective due to the lack of any constraint on the objective. In EPS-CPO we set the reconciliation parameter λ=3. Empericially, we found that λ=3 balanced reasonably well between the surrogate reward and the agent's reward.

In SEPS, we set d₀=0.0 and d₁=2.5. Note that these bounds have clear semantic meanings (e.g., the sub-optimality level under the respective metric), which makes them easier to specify than the hyper-parameters in EPS. It is worth noting that unlike SEPS, all baselines have a single constraint on safety. Addressing multiple constraints is more challenging since they may sometimes conflict with each other. Even under such a case, SEPS stayed close to [symbol] _{A}-CPO under both [symbol] _{A} and the safety cost. In other words, it is able to remain explicable while sufficiently satisfying both the performance and safety requirements.

The behaviors generated by different methods for an example seed in the PointButton task are shown in FIG. 10B. In SEPS and EPS-CPO the agent pressed a single button before reaching the goal. However, in EPS-CPO the agent showed a suboptimal behavior by taking a longer path to the button and going around the button before reaching the goal. As expected, in u_{H}-CPO the agent pressed both buttons while in [symbol] _{A}-CPO it headed straight to the goal.

### 2.6.3. Physical Robot Experiment

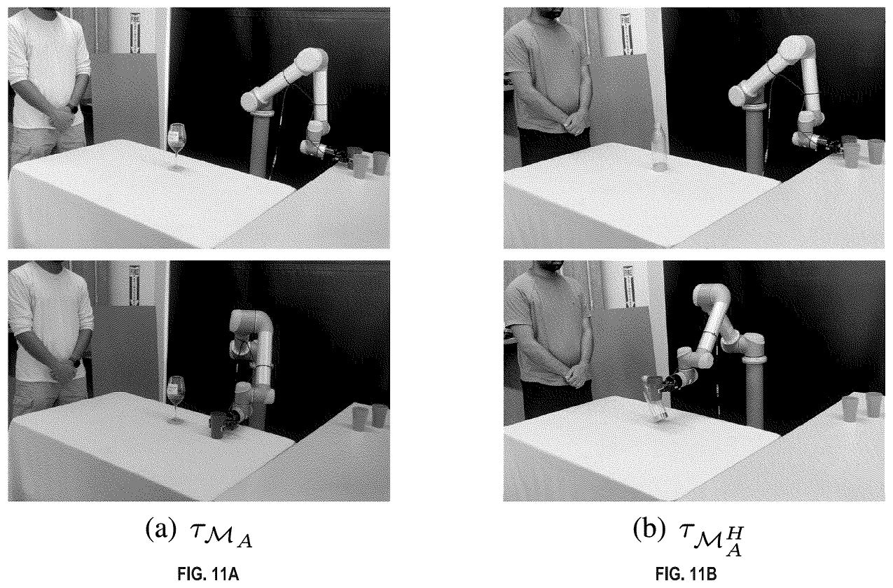

In this experiment, our aim is to analyze the behaviors generated when a physical robot (UR5) assists a user to set up a dining table. We designed the experiment (see FIGS. 11A and 11B) in a discrete setting where the location of the objects was preset to specific waypoints, and the robot's movement between them was calibrated using the UR5's inverse kinematics library.

We assume that the user's expectations differ from the robot's functionality. The robot is required to pass the cups to the user by placing them on the dining table. The user expects the robot to place the cups close to where he is standing. However, doing so may tip the glass in front of the robot. Tipping the glass will spill its contents, which is unsafe in the robot's model and has a high cost. We analyzed the behavior generated by SEPS and compared it with the optimal behavior in its own model, the user's expected behavior, and EPS-CPO.

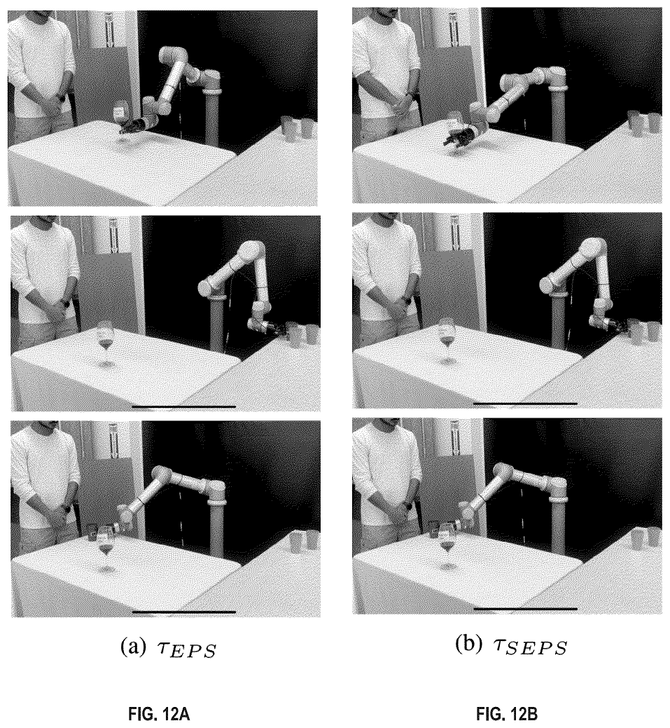

The robot picked the cup and placed it on the table next to the glass when executing the optimal behavior in its model (see FIG. 11A). When executing the user's expected behavior, the robot tipped the glass (replaced by an empty plastic bottle in this execution for safety reasons), as shown in FIG. 11B. In reality, the robot would have spilled the liquid as the glass obstructed the manipulator. With EPS (see FIG. 12A), the robot first picked up the glass and moved it across the table. Then, it picked up the cup and placed it close to the user to meet his expectation. However, picking and placing the glass was less efficient due to additional movements. With SEPS (see FIG. 12B), the robot first moved the manipulator to push the glass gently across the table to clear it out of the way. Then, it picked up the cup and placed it close to the user as in EPS. While both EPS and SEPS generated explicable behaviors, SEPS's is more efficient, thanks to the constraint on the task objective.

### 2.7. Conclusion

In this section, we introduced a formulation for Safe Explicable Policy Search (SEPS) applied for continuous stochastic environments, which aimed to search for explicable policies while considering both safety and task efficiency. We adopted and adapted the explicability measure in EPS to formulate SEPS as a CMDP. SEPS relaxed the need for specifying multiple hyper-parameters for explicable policy search by considering the agent's task objective as a separate constraint. These treatments allowed us to apply CPO to solve SEPS to satisfy the safety and quality requirements during the learning process while maximizing explicability. We derived an analytical solution for the most common case of SEPS with two constraints. We evaluated SEPS for safety and efficiency in safety-gym environments. The results demonstrated that SEPS was effective in learning safe, explicable, and efficient policies. We also demonstrated the applicability of our approach via a physical robot experiment.

### 2.8 Analytical Solution for Seps

The SEPS problem is approximated by

$${θ}_{n + 1} = arg {max}_{θ} {g}^{T} ( θ - {θ}_{n} ) \qquad ( 20 )$$

$$s . t . {c}_{0} - {b}_{0}^{T} ( θ - {θ}_{n} ) \leq 0$$

$${c}_{i} + {b}_{i}^{T} ( θ - {θ}_{n} ) \leq 0 i = 1 , … , k$$

$$\frac{1}{2} {( θ - {θ}_{n} )}^{T} H ( θ - {θ}_{n} ) \leq δ$$

Let x=θ−θₙ. Here, we derive the solution for the special case with a single cost function [symbol] ₁ which results in a total of two constraints. The resulting objective with linear and quadratic constraints is discussed under the feasible and infeasible case.

### 2.8.1 Feasible Case

Theorem 1 Consider the following problem

$${p}^{*} = {min}_{x} {g}^{T} x$$

$$s . t . {b}_{0}^{T} x + {c}_{0} \leq 0$$

$${b}_{1}^{T} x + {c}_{1} \leq 0$$

$$\frac{1}{2} {x}^{T} H x \leq δ$$

where g, b, x∈ [symbol] ^{l}, c, δ∈ [symbol] ^{l} and H [symbol] 0. When there is at least one strictly feasible point, the optimal point x* satisfies the following condition

$${x}^{*} = - \frac{1}{{λ}^{*}} {H}^{- 1} ( g + {v}_{0}^{*} {b}_{0} + {v}_{1}^{*} {b}_{1} )$$

where, λ*, v*₀, and v*₁ are defined by

case 1: When v₀>0 and v₁>0

$${v}_{0}^{*} = \frac{{λ}_{{𝒞}_{0}} - {v}_{1} t - {r}_{0}}{{s}_{0}} {v}_{1}^{*} = \frac{{λ}_{{𝒞}_{1}} - {v}_{0} t - {r}_{1}}{{s}_{1}}$$

$${λ}^{*} = arg {max}_{λ \geq 0} \{ \begin{matrix}{f}_{1 ( λ )} & if \frac{\begin{matrix}λ ( {s}_{1} {c}_{0} - {tc}_{1} ) + \\ {tr}_{1} - {s}_{1} {r}_{0}\end{matrix}}{{s}_{0} {s}_{1} - {t}^{2}} > 0 and \frac{\begin{matrix}λ ( {s}_{0} {c}_{1} - {tc}_{0} ) + \\ {tr}_{0} - {s}_{0} {r}_{1}\end{matrix}}{{s}_{0} {s}_{1} - {t}^{2}} > 0 \\ {f}_{4 ( λ )} & otherwise\end{matrix}$$

case 2: When v₀>0 and v₁=0

$${v}_{0}^{*} = \frac{λ {c}_{0} - {r}_{0}}{{s}_{0}} {v}_{1}^{*} = 0$$

$${λ}^{*} = arg {max}_{λ \geq 0} \{ \begin{matrix}{f}_{2} ( λ ) & if \frac{λ {c}_{0} - {r}_{0}}{{s}_{0}} > 0 \\ {f}_{4} ( λ ) & otherwise\end{matrix}$$

Case 3: When v₀=0 and v₁>0

$${v}_{0}^{*} = 0 {v}_{1}^{*} = \frac{λ {c}_{1} - {r}_{1}}{{s}_{1}} \\ {λ}^{*} = arg {max}_{λ \geq 0} \{ \begin{matrix}{f}_{3} ( λ ) & if \frac{λ {c}_{1} - {r}_{1}}{{s}_{1}} > 0 \\ {f}_{4} ( λ ) & othewise\end{matrix}$$

Case 4: When v₀=0 and v₁=0

$${v}_{0}^{*} = 0 {v}_{1}^{*} = 0 \\ {λ}^{*} = {max}_{λ \geq 0} {f}_{4} ( λ )$$

where,

$${f}_{1} ( λ ) \dot{=} \frac{1}{2 λ} ( - q ) + \frac{λ}{2} ( \frac{{s}_{1} {c}_{0}^{2} + {s}_{0} {c}_{1}^{2} - 2 t {c}_{0} {c}_{1}}{{s}_{0} {s}_{1} - {t}^{2}} - 2 δ ) + \frac{{tr}_{1} {c}_{0} + {tr}_{0} {c}_{1} - {s}_{1} {r}_{0} {c}_{0} - {s}_{0} {r}_{1} {c}_{1} - {s}_{1} {r}_{0}^{2} - {s}_{0} {r}_{1}^{2} + 2 {tr}_{0} {r}_{1}}{{s}_{0} {s}_{1} - {t}^{2}} \\ {f}_{2} ( λ ) \dot{=} \frac{1}{2 λ} ( \frac{{r}_{0}^{2}}{{s}_{0}} - q ) + \frac{λ}{2} ( \frac{{c}_{0}^{2}}{{s}_{0}} - 2 δ ) - \frac{{r}_{0} {c}_{0}}{{s}_{0}} \\ {f}_{3} ( λ ) \dot{=} \frac{1}{2 λ} ( \frac{{r}_{1}^{2}}{{s}_{1}} - q ) + \frac{λ}{2} ( \frac{{c}_{1}^{2}}{{s}_{1}} - 2 δ ) - \frac{{r}_{1} {c}_{1}}{{s}_{1}} \\ {f}_{4} ( λ ) \dot{=} \frac{1}{2 λ} ( - q ) + \frac{λ}{2} ( - 2 δ )$$

with q=g^{T}H⁻¹g, r₀=g^{T}H⁻¹b₀, t₁=g^{T}H⁻¹b₁, s₀=b₀^{T}H⁻¹b₀, s₁=b₁^{T}H⁻¹b₁, t=b₀^{T}H⁻¹b₁.

Proof: This is a convex optimization problem. When there is at least one strictly feasible point, strong duality holds by Slater's theorem. The dual to the above problem is

$$\begin{matrix}{p}^{*} = {min}_{x} {max}_{λ \geq 0 , {v}_{0} \geq 0 , {v}_{1} \geq 0} {g}^{T} x + λ ( \frac{1}{2} {x}^{T} H x - δ ) + {v}_{0} ( {b}_{0}^{T} x + {c}_{0} ) + {v}_{1} ( {b}_{1}^{T} x + {c}_{1} ) \\ = {max}_{λ \geq 0 , {v}_{0} \geq 0 , {v}_{1} \geq 0} {min}_{x} \frac{λ}{2} {x}^{T} H x + ( {g}^{T} + {v}_{0} {b}_{0}^{T} + {v}_{1} {b}_{1}^{T} ) x + {v}_{0} {c}_{0} + {v}_{1} {c}_{1} - λδ\end{matrix} \qquad ( 21 )$$

$$( Strong duality ) \frac{\partial ℒ ( x , λ , {v}_{0} , {v}_{1} )}{\partial x} = \frac{λ}{2} 2 x H + g + {v}_{0} {b}_{0} + {v}_{1} {b}_{1} ( Stationary condition ) \{ \frac{\partial L}{\partial x} = 0 \} ∴ {x}^{*} = - \frac{1}{λ} {H}^{- 1} ( g + {v}_{0} {b}_{0} + {v}_{1} {b}_{1} ) \qquad ( 22 )$$

### Substitute x* in Eq. (3):

$${p}^{*} = {max}_{λ \geq {v}_{0} \geq 0 , {v}_{1} \geq 0} \frac{λ}{2} {( \frac{- 1}{λ} {H}^{- 1} ( g + {v}_{0} {b}_{0} + {v}_{1} {b}_{1} ) )}^{T} H ( \frac{- 1}{λ} {H}^{- 1} ( g + {v}_{0} {b}_{0} + {v}_{1} {b}_{1} ) ) + {( {g}^{T} + {v}_{0} {b}_{0}^{T} + {v}_{1} {b}_{1}^{T} )}^{T} ( \frac{- 1}{λ} {H}^{- 1} ( g + {v}_{0} {b}_{0} + {v}_{1} {b}_{1} ) ) + {v}_{0} {c}_{0} + {v}_{1} {c}_{1} - λδ = {max}_{λ \geq {v}_{0} \geq 0 , {v}_{1} \geq 0} - \frac{1}{2 λ} ( {g}^{T} {H}^{- 1} g + {v}_{0} {g}^{T} {H}^{- 1} {b}_{0} + {v}_{1} {g}^{T} {H}^{- 1} {b}_{1} + {v}_{0} {b}_{0}^{T} {H}^{- 1} g + {v}_{0}^{2} {b}_{0}^{T} {H}^{- 1} {b}_{k} + {v}_{0} {v}_{1} {b}_{0}^{T} {H}^{- 1} {b}_{0} + {v}_{0} {v}_{1} {b}_{o}^{T} {H}^{- 1} {b}_{1} + {v}_{1} {b}_{1}^{T} {H}^{- 1} g + {v}_{0} {v}_{1} {b}_{1}^{T} {H}^{- 1} {b}_{0} + {v}_{1}^{2} {b}_{1}^{T} {H}^{- 1} {b}_{1} ) + {v}_{0} {c}_{0} + {v}_{1} {c}_{1} - λδ \qquad ( 23 )$$

$$Let q = {g}^{T} {H}^{- 1} g , {r}_{0} = {g}^{T} {H}^{- 1} {b}_{0} , {r}_{1} = {g}^{T} {H}^{- 1} {b}_{1} , {s}_{0} = {b}_{0}^{T} {H}^{- 1} {b}_{0} , {s}_{1} = {b}_{1}^{T} {H}^{- 1} {b}_{1} , \begin{matrix}t = {b}_{0}^{T} {H}^{- 1} {b}_{1} \\ = {max}_{λ \geq {v}_{0} \geq 0 , {v}_{1} \geq 0} - \frac{1}{2 λ} ( q + 2 {v}_{0} {r}_{0} + 2 {v}_{1} {r}_{1} + {v}_{0}^{2} {s}_{0} + {v}_{1}^{2} {s}_{1} + 2 {v}_{0} {v}_{1} t ) + \\ {v}_{o} {c}_{0} + {v}_{1} {c}_{1} - λ δ\end{matrix}$$

Case 1: When v₀>0 and v₁>0
Here, both constraints are active.
Optimizing single-variable convex quadratic function over [symbol] ₊ for v₀ (i.e. for fixed value of λ and v₁ find the value of v₀)

$$\frac{\partial ℒ ( λ , {v}_{0} , {v}_{1} )}{\partial {v}_{0}} = - \frac{1}{2 λ} ( 2 {r}_{0} + 2 {v}_{0} {s}_{0} + 2 {v}_{1} t ) + {c}_{0} \frac{\partial L}{\partial {v}_{0}} = 0 ∴ {v}_{0} = \frac{{λ}_{{c}_{0} - {v}_{1} t - {r}_{0}}}{{s}_{0}} \qquad ( 24 )$$

Optimizing single-variable convex quadratic function over [symbol] ₊ for v₁ (i.e. for fixed value of λ and v₀ find the value of v₁)

$$\frac{\partial ℒ ( λ , {v}_{0} , {v}_{1} )}{\partial {v}_{1}} = - \frac{1}{2 λ} ( 2 {r}_{1} + 2 {v}_{1} {s}_{1} + 2 {v}_{0} t ) + {c}_{1} \frac{\partial L}{\partial {v}_{1}} = 0 ∴ {v}_{1} = \frac{{λ}_{{c}_{1} - {v}_{0} t - {r}_{1}}}{{s}_{1}} \qquad ( 25 )$$

Solving Eq. 24 and Eq. 25 simultaneously, we get

$$∴ {v}_{0} = \frac{λ ( {s}_{1} {c}_{0} - t {c}_{1} ) + t {r}_{1} - {s}_{1} {r}_{0}}{{s}_{0} {s}_{1} - {t}^{2}} \qquad ( 26 )$$

$$∴ {v}_{1} = \frac{λ ( {s}_{0} {c}_{1} - t {c}_{0} ) + t {r}_{0} - {s}_{0} {r}_{1}}{{s}_{0} {s}_{1} - {t}^{2}} \qquad ( 27 )$$

Substitute the values of v₀ and v₁ above in Eq. (23), we get

$${p}^{*} = {max}_{λ \geq 0} {f}_{1} ( λ ) \dot{=} \frac{λ}{2 λ} ( - q ) + \frac{λ}{2} ( \frac{{s}_{1} {c}_{0}^{2} + {s}_{0} {c}_{1}^{2} - 2 t {c}_{{0}^{{C}_{1}}}}{{s}_{0} {s}_{1} - {t}^{2}} - 2 δ ) + \frac{t {r}_{1} {c}_{0} + t {r}_{0} {c}_{1} - {s}_{1} {r}_{0} {c}_{0} - {s}_{0} {r}_{1} {c}_{1} - {s}_{1} {r}_{0}^{2} - {s}_{0} {r}_{1}^{2} + 2 t {r}_{0} {r}_{1}}{{s}_{0} {s}_{1} - {t}^{2}} \qquad ( 28 )$$

Optimize Eq. (28) if λ∈Λ₁, where

$${Λ}_{1} = \{ λ \vert \frac{λ ( {s}_{1} {c}_{0} - t {c}_{1} ) + t {r}_{1} - {s}_{1} {r}_{0}}{{s}_{0} {s}_{1} - {t}^{2}} > 0 , \frac{λ ( {s}_{0} {c}_{1} - t {c}_{0} ) + t {r}_{0} - {s}_{0} {r}_{1}}{{s}_{0} {s}_{1} - {t}^{2}} > 0 , λ \geq 0 \}$$

Case 2: When v₀>0 and v₁=0
Here, the 1^{st} constraint is active and the 2^{nd} constraint is inactive.
Set v₁=0 in Eq. (23), we get

$${p}^{*} = {max}_{λ \geq 0 , {v}_{0} \geq 0} - \frac{1}{2 λ} ( q + 2 {v}_{0} {r}_{0} + {v}_{0}^{2} {s}_{0} ) + {v}_{0} {c}_{0} - λδ \qquad ( 29 )$$

$$\frac{\partial L}{\partial {v}_{0}} = 0 ∴ {v}_{0} = \frac{{λ}_{{c}_{0} - {r}_{0}}}{{s}_{0}} \qquad ( 30 )$$

Substitute the value of v₀ above in Eq. 29, we get

$${p}^{*} = {max}_{λ \geq 0} {f}_{2} ( λ ) \dot{=} \frac{1}{2 λ} ( \frac{{r}_{0}^{2}}{{s}_{0}} - q ) + \frac{λ}{2} ( \frac{{c}_{0}^{2}}{{s}_{0}} - 2 δ ) - \frac{{r}_{0} {c}_{0}}{{s}_{0}} \qquad ( 31 )$$

Optimize Eq. (31) if λ∈Λ₂, where

$${Λ}_{2} = \{ λ \vert \frac{λ {c}_{0} - {r}_{0}}{{s}_{0}} > 0 , λ \geq 0 \}$$

Case 3: When v₀=0 and v₁>0
Here, the 1^{st} constraint is inactive and the 2^{nd} constraint is active.
Set v₀=0 in Eq. (23), we get

$${p}^{*} = {max}_{λ \geq 0 , {v}_{1} \geq 0} - \frac{1}{2 λ} ( q + 2 {v}_{1} {r}_{1} + {v}_{1}^{2} {s}_{1} ) + {v}_{1} {c}_{1} - λδ \qquad ( 32 )$$

$$\frac{\partial L}{\partial {v}_{1}} = 0 ∴ {v}_{1} = \frac{λ {c}_{1} - {r}_{1}}{{s}_{1}} \qquad ( 33 )$$

Substitute the value of v₁ above in Eq. 32, we get

$${p}^{*} = {max}_{λ \geq 0} {f}_{3} ( λ ) \dot{=} \frac{1}{2 λ} ( \frac{{r}_{1}^{2}}{{s}_{1}} - q ) + \frac{λ}{2} ( \frac{{c}_{1}^{2}}{{s}_{1}} - 2 δ ) - \frac{{r}_{1} {c}_{1}}{{s}_{1}} \qquad ( 34 )$$

Optimize Eq. (34) if λ∈Λ₃, where

$${Λ}_{3} = \{ λ \vert \frac{λ {c}_{1} - {r}_{1}}{{s}_{1}} > 0 , λ \geq 0 \}$$

Case 4: When v₀=0 and v₁=0
Here, both constraints are inactive.
Set v₀=0 and v₁=0 in Eq. (23), we get

$${p}^{*} = {max}_{λ \geq 0} {f}_{4} ( λ ) \dot{=} \frac{1}{2 λ} ( - q ) + \frac{λ}{2} ( - 2 δ ) \qquad ( 35 )$$

Optimize Eq. (35) if λ∈Λ₄, where

$${Λ}_{4} = \{ λ \vert \frac{λ ( {s}_{1} {c}_{0} - t {c}_{1} ) + t {r}_{1} - {s}_{1} {r}_{0}}{{s}_{0} {s}_{1} - {t}^{2}} \leq 0 , \frac{λ ( {s}_{0} {c}_{1} - t {c}_{0} ) + t {r}_{0} - {s}_{0} {r}_{1}}{{s}_{0} {s}_{1} - {t}^{2}} \leq 0 , \\ \frac{λ {c}_{0} - {r}_{0}}{{s}_{0}} \leq 0 , \frac{λ {c}_{1} - {r}_{1}}{{s}_{1}} \} \leq 0 , λ \geq 0$$

In summary, solving the dual for λ: for any A>0, B>0, the problem

$${max}_{λ \geq 0} f ( λ ) \dot{=} - \frac{1}{2} ( \frac{A}{λ} + B λ ) \qquad ( 36 )$$

has optimal point λ*=\sqrt{A/B} and optimal value ƒ(λ*)=\sqrt{A/B}.

If λ*, v*₀, and v*₁ are a solution to the dual above. The update rule for the feasible case is

$${θ}_{n + 1} = {θ}_{n} - \frac{1}{λ} {H}^{- 1} ( g + {v}_{0} {b}_{0} + {v}_{1} {b}_{1} ) \qquad ( 37 )$$

### 2.8.2 Infeasible Case

Theorem 2 Consider the following problem

$$\hat{p} = {min}_{θ} {c}_{m} - {b}_{m}^{T} ( θ - {θ}_{n} )$$

$$s . t . \frac{1}{2} {( θ - {θ}_{n} )}^{T} H ( θ - {θ}_{n} ) \leq δ$$

where m∈[0, k], b, x ∈ [symbol] ^{l}, c, δ∈ [symbol] ^{l} and H [symbol] 0. When there is at least one strictly feasible point, the optimal point x* satisfies the following condition

$${x}^{*} = - \frac{1}{{ϕ}^{*}} {H}^{- I} {b}_{m}$$

where, ϕ* is defined by

$${ϕ}^{*} = \sqrt{\frac{s}{2 δ}}$$

with s=bₘ^{T}H⁻¹bₘ.

Proof: This is a convex optimization problem. When there is at least one strictly feasible point, strong duality holds by Slater's theorem. The dual to the above problem is

$$\hat{p} = {min}_{x} {max}_{ϕ \geq 0} {b}_{m}^{T} x + {c}_{m} + ϕ ( \frac{1}{2} {x}^{T} H x - δ ) \qquad ( 38 )$$

$$\hat{p} = {max}_{ϕ \geq 0} {min}_{x} \frac{ϕ}{2} {x}^{T} H x + {b}_{m}^{T} x + {c}_{m} - ϕδ \qquad ( 39 )$$

$$( Strong duality )$$

$$\frac{\partial ℒ ( x , ϕ )}{\partial x} = \frac{ϕ}{2} 2 x H + {b}_{m}$$

$$( Stationary condition \{ \frac{\partial L}{\partial x} = 0 \}$$

$$∴ {x}^{*} = - \frac{1}{ϕ} {H}^{- 1} {b}_{m}$$

Substitute x* in Eq. 39:

$$\hat{p} = {max}_{ϕ \geq 0} \frac{ϕ}{2} {( \frac{- 1}{ϕ} {H}^{- I} {b}_{m} )}^{T} H ( \frac{- 1}{ϕ} {H}^{- 1} {b}_{m} ) + {b}_{m}^{T} ( \frac{- 1}{ϕ} {H}^{- 1} {b}_{m} ) + {c}_{m} - ϕδ = {max}_{ϕ \geq 0} - \frac{{b}_{m}^{T} {H}^{- 1} {b}_{m}}{2 ϕ} + {c}_{m} - ϕ δ$$

Let s=bₘ^{T}H⁻¹bₘ.

$$= {max}_{ϕ \geq 0} - \frac{s}{2 ϕ} + {c}_{m} - ϕδ$$

$$\frac{\partial ℒ ( ϕ )}{\partial ϕ} = - \frac{s}{2} ( - \frac{1}{{ϕ}^{2}} ) - δ$$

$$( Stationary condition ) \{ \frac{\partial L}{\partial x} = 0 \}$$

$$∴ {ϕ}^{*} = \sqrt{\frac{s}{2 δ}}$$

If ϕ* is the solution to the dual above. The update rule for the infeasible case is

$${θ}_{n + 1} = {θ}_{n} - √ \frac{2 δ}{s} {H}^{- 1} {b}_{m} \qquad ( 40 )$$

### 2.9 Algorithm

Algorithm 3: SEPS

```
Input: u_{H}, [symbol]   _{A}, { [symbol]   ᵢ}_{i=1:k}, {dᵢ}_{i=0:k}
Initialize θ₀; π₀ = π(θ₀);
for n = 0,1,2, ... do
  Sample a set of trajectories
  Compute estimates for
  If feasible then
    Solve dual problem in Eq. 15 for λ*, ν*;
    Compute policy update θₙ₊₁ as in Eq. 16;
  Else
    While not feasible do perform line search until policy update θₙ₊₁
      is feasible
        Solve dual problem in Eq. 18 for ϕ*;
        Compute policy update θₙ₊₁ as in Eq. 19;
    End while
  End if
End for
```

A computer-implemented method includes: accessing task information about a task to be completed by a computer-implemented agent; accessing perception data captured by the computer-implemented agent with respect to the task; and evaluating a current policy with respect to the safety constraint and the task constraint based on the perception data.

The method further includes: determining, based on the task information and by iterative modification of one or more policy parameters θ of a policy it descriptive of one or more task-oriented actions, one or more updated policy parameters of an updated policy descriptive of an updated set of task-oriented actions for completion of the task by the computer-implemented agent that: (a) satisfies a task constraint associated with the task and a safety constraint on a robot-oriented expected return value associated with a robot-oriented reward for the updated set of task-oriented actions; and (b) maximizes a human-oriented expected return value associated with a human-oriented reward (which can be represented as surrogate reward function u_{H}) for the updated set of task-oriented actions.

The step of determining the updated policy parameters can be achieved by: sampling, for an iteration of a plurality of iterations, a set of trajectories {τ} from a probability distribution associated with the policy πₙ; estimating one or more optimization parameter values (g, b₀, bᵢ, H⁻¹x, c₀, Cᵢ) associated with the set of trajectories {τ}; evaluating a feasibility of the policy based on the set of trajectories with respect to the task constraint, the safety constraint, and perception data captured by the computer-implemented agent with respect to the task; solving a dual optimization function based on the feasibility (e.g., either Eq. 15 if the current policy is feasible or Eq. 18 if the current policy is infeasible); and determining the updated policy parameters eθₙ₊₁ of the updated policy πₙ₊₁ based on the one or more optimization parameter values (g, b₀, bᵢ, H⁻¹x, c₀, Cᵢ) and the solution to the dual optimization function, the updated policy parameters corresponding with a most expected trajectory of the computer-implemented agent with respect to the human-oriented reward that satisfies the task constraint and the safety constraint.

When the current policy is a feasible policy with respect to the task constraint and the safety constraint, the method can include solving a first dual optimization function (Eq. 15), and the solution includes a Lagrangian (λ*) of a trust region constraint of the first dual optimization function and a Lagrangian (v*) of a linear constraint of the first dual optimization function. The solution is then used to determine the updated policy parameters using Eq. 16.

When the current policy is an infeasible policy with respect to the task information and the safety bound, the method can include solving a second dual optimization function (Eq. 18) that aims to reduce a violation of the task constraint or the safety constraint, and the solution including a Lagrangian (ϕ*) for the constraint

$$\frac{1}{2} {( θ - {θ}_{n} )}^{T} H ( θ - {θ}_{n} ) \leq δ$$

of the optimization function Eq. 17, the dual of which is a second dual optimization function Eq. 18. The solution is then used to determine the updated policy parameters using Eq. 19.

After the final iteration, the method can further include: generating a control output for execution of the one or more task-oriented actions by the computer-implemented agent based on the updated policy with respect to the task information.

The functions performed in the processes and methods may be implemented in differing order. Furthermore, the outlined steps and operations are provided as examples, and some of the steps and operations may be optional, combined into fewer steps and operations, or expanded into additional steps and operations without detracting from the essence of the disclosed embodiments.

It should be understood from the foregoing that, while particular embodiments have been illustrated and described, various modifications can be made thereto without departing from the spirit and scope of the invention as will be apparent to those skilled in the art. Such changes and modifications are within the scope and teachings of this invention as defined in the claims appended hereto.

What is claimed is:

1. A system, comprising:
a processor in communication with a memory, the memory including instructions executable by the processor to:
access task information about a task to be completed by a computer-implemented agent;
determine, based on the task information and by iterative modification of one or more policy parameters of a policy descriptive of one or more task-oriented actions, one or more updated policy parameters of an updated policy descriptive of an updated set of task-oriented actions for completion of the task by the computer-implemented agent that:
(a) satisfies a task constraint associated with the task and a safety constraint on a robot-oriented expected return value associated with a robot-oriented reward for the updated set of task-oriented actions; and
(b) maximizes a human-oriented expected return value associated with a human-oriented reward for the updated set of task-oriented actions; and
generate a control output for execution of the one or more task-oriented actions by the computer-implemented agent based on the updated policy with respect to the task information.

2. The system of claim 1, the memory further including instructions executable by the processor to:
access perception data captured by the computer-implemented agent with respect to the task; and
evaluate the policy with respect to the safety constraint and the task constraint based on the perception data.

3. The system of claim 1, the memory further including instructions executable by the processor to:
sample, for an iteration of a plurality of iterations, a set of trajectories from a probability distribution associated with the policy;
estimate one or more optimization parameter values associated with the set of trajectories; and
determine the updated policy parameters of the updated policy based on the one or more optimization parameter values and a dual optimization function, the updated policy parameters corresponding with a most expected trajectory of the computer-implemented agent with respect to the human-oriented reward that satisfies the task constraint and the safety constraint.

4. The system of claim 3, the set of trajectories corresponding with one or more task-oriented actions of the policy.

5. The system of claim 3, the memory further including instructions executable by the processor to:
evaluate a feasibility of the policy based on the set of trajectories with respect to the task constraint, the safety constraint, and perception data captured by the computer-implemented agent with respect to the task.

6. The system of claim 5, the policy being a feasible policy with respect to the task constraint and the safety constraint, the dual optimization function being a first dual optimization function, and a solution including a Lagrangian of a trust region constraint of the first dual optimization function and a Lagrangian of a linear constraint of the first dual optimization function.

7. The system of claim 5, the policy being an infeasible policy with respect to the task information and the safety constraint, the dual optimization function being a second dual optimization function that aims to reduce a violation of the task constraint or the safety constraint, and a solution including a Lagrangian of a constraint of the second dual optimization function.

8. A method, comprising:
accessing, at a processor in communication with a memory, task information about a task to be completed by a computer-implemented agent;
determining, at the processor and based on the task information and by iterative modification of one or more policy parameters of a policy descriptive of one or more task-oriented actions, one or more updated policy parameters of an updated policy descriptive of an updated set of task-oriented actions for completion of the task by the computer-implemented agent that:
(a) satisfies a task constraint associated with the task and a safety constraint on a robot-oriented expected return value associated with a robot-oriented reward for the updated set of task-oriented actions; and
(b) maximizes a human-oriented expected return value associated with a human-oriented reward for the updated set of task-oriented actions; and
generating, at the processor, a control output for execution of the one or more task-oriented actions by the computer-implemented agent based on the updated policy with respect to the task information.

9. The method of claim 8, further comprising:
accessing, at the processor, perception data captured by a sensor device of the computer-implemented agent with respect to the task; and
evaluating, at the processor, the policy with respect to the safety constraint and the task constraint based on the perception data.

10. The method of claim 8, further comprising:
sampling, at the processor and for an iteration of a plurality of iterations, a set of trajectories from a probability distribution associated with the policy;
estimating, at the processor, one or more optimization parameter values associated with the set of trajectories; and
determining, at the processor, the updated policy parameters of the updated policy based on the one or more optimization parameter values and a dual optimization function, the updated policy parameters corresponding with a most expected trajectory of the computer-implemented agent with respect to the human-oriented reward that satisfies the task constraint and the safety constraint.

11. The method of claim 10, the set of trajectories corresponding with one or more task-oriented actions of the policy.

12. The method of claim 10, further comprising:
evaluating, at the processor, a feasibility of the policy based on the set of trajectories with respect to the task constraint, the safety constraint, and perception data captured by the computer-implemented agent with respect to the task.

13. The method of claim 12, the policy being a feasible policy with respect to the task constraint and the safety constraint, the dual optimization function being a first dual optimization function, and a solution including a Lagrangian of a trust region constraint of the first dual optimization function and a Lagrangian of a linear constraint of the first dual optimization function.

14. The method of claim 12, the policy being an infeasible policy with respect to the task information and the safety constraint, the dual optimization function being a second dual optimization function that aims to reduce a violation of the task constraint or the safety constraint, and a solution including a Lagrangian of a constraint of the second dual optimization function.

15. A non-transitory computer readable medium comprising instructions stored thereon, which, when executed, the instructions are effective to cause at least one processor to:
access task information about a task to be completed by a computer-implemented agent;
determine, based on the task information and by iterative modification of one or more policy parameters of a policy descriptive of one or more task-oriented actions, one or more updated policy parameters of an updated policy descriptive of an updated set of task-oriented actions for completion of the task by the computer-implemented agent that:
(a) satisfies a task constraint associated with the task and a safety constraint on a robot-oriented expected return value associated with a robot-oriented reward for the updated set of task-oriented actions; and
(b) maximizes a human-oriented expected return value associated with a human-oriented reward for the updated set of task-oriented actions; and
generate a control output for execution of the one or more task-oriented actions by the computer-implemented agent based on the updated policy with respect to the task information.

16. The non-transitory computer readable medium of claim 15, further comprising instructions stored thereon, which, when executed, the instructions are effective to cause the at least one processor to:
access perception data captured by the computer-implemented agent with respect to the task; and
evaluate the policy with respect to the safety constraint and the task constraint based on the perception data.

17. The non-transitory computer readable medium of claim 15, further comprising instructions stored thereon, which, when executed, the instructions are effective to cause the at least one processor to:
sample, for an iteration of a plurality of iterations, a set of trajectories from a probability distribution associated with the policy;
estimate one or more optimization parameter values associated with the set of trajectories; and
determine the updated policy parameters of the updated policy based on the one or more optimization parameter values and an optimization function, the updated policy parameters corresponding with a most expected trajectory of the computer-implemented agent with respect to the human-oriented reward that satisfies the task constraint and the safety constraint.

18. The non-transitory computer readable medium of claim 17, the set of trajectories corresponding with one or more task-oriented actions of the policy.

19. The non-transitory computer readable medium of claim 17, further comprising instructions stored thereon, which, when executed, the instructions are effective to cause the at least one processor to:
evaluate a feasibility of the policy based on the set of trajectories with respect to the task constraint, the safety constraint, and perception data captured by the computer-implemented agent with respect to the task.

20. The non-transitory computer readable medium of claim 19, the policy being an infeasible policy with respect to the task information and the safety constraint, the optimization function aiming to reduce a violation of the task constraint or the safety constraint, and a solution including a Lagrangian of a constraint of the dual optimization function.
